(19) United States
(12) Patent Application Publication
(10) Pub. No.: US 2012/0284087 A1
(43) Pub. Date: Nov. 8, 2012

(54) System and Method for Providing Competitive Pricing for Automobiles

(75) Inventor: Dale Pollak, Hinsdale, IL (US)

(73) Assignee: AUTOTRADER.COM, INC., Atlanta, GA (US)

(21) Appl. No.: 13/444,513

(22) Filed: Apr. 11, 2012

Related U.S. Application Data
(62) Division of application No. 12/586,002, filed on Sep. 15, 2009.
Application No. 12/586,002 is a continuation-in-part of application No. 12/077,081, filed on Mar. 14, 2008.
(60) Provisional application No. 60/931,717, filed on May 25, 2007.
(60) Provisional application No. 60/918,552, filed on Mar. 16, 2007.

(51) Int. Cl. G06Q 30/02

(52) U.S. Cl. 705/7.35

(57) ABSTRACT

The invention includes a method and system to provide a competitive pricing tool so that automobile dealers can more efficiently and effectively price their used vehicles. The system achieves the optimal sales price by obtaining the relevant pricing and mileage of vehicles for sale that are similarly situated to the focus vehicle. Once the information is obtained, the system creates a value ranking for each of the vehicles for sale and for the focus vehicle. The user is then able to revise the focus vehicle pricing to determine the optimal sales price.

This application claims the benefit of U.S. Provisional Application No. 60/918,552, filed Mar. 16, 2007, U.S. Provisional Application No. 60/931,717, filed May 25, 2007 and U.S. patent application Ser. No. 12/077,081, filed Mar. 14, 2008.

### FIELD OF THE INVENTION

The present invention relates to a novel competitive pricing, marketing, reporting and writing system and method directed to assist retailers in more effectively and efficiently pricing and marketing their products. The system has features especially adapted for use with the used vehicle business environment; although it is contemplated that alternate embodiments of the invention would be applicable to other types of businesses. A novel ranking system is utilized that recognizes the relationship of certain variables to the price of the goods thereby simulating the consumer's mental process of narrowing and prioritizing a wide range of generally similar products into a manageable list. A novel generator prepares descriptions of the goods, while a novel reporting system is utilized to report to and monitor the activities of potential customers that have shown an interest in a particular product, for example, an automobile for sale.

In the preferred embodiment, the system of the present invention recognizes a relationship between a used car's mileage and the price. The present invention ranks competitive vehicles based on at least this relationship, and provides an automobile dealer with information about the pricing for that particular dealer's used cars. The retailer can revise its prices accordingly to decrease the amount of time to sell the used vehicle, increase the profit from the sale of the used vehicle, or both. Thus, the system and method assists the retailer in determining optimal pricing for the sale of a used car based on the retailer's objectives. The preferred embodiment also provides information to the potential customer about the product, i.e., an automobile that the customer intends to purchase. That information, relating to other similar products for sale in a particular geographical area, can be accessed at the point of sale, or by the customer at a later time and place. The party offering the product for sale is informed each time the customer accesses the information, thereby indicating the level of interest by the customer. This novel price delivery system for the dealer, along with the unique transparency to the customer, aligns the sales process with the buying experience, especially the Internet-based buying experience.

### BACKGROUND OF THE INVENTION

The pre-owned vehicle market is quite substantial. It has been estimated that there are in existence over 50,000 pre-owned vehicle locations in the U.S. when franchises and independent locations are considered. As many as 25 million vehicles are acquired and sold from these businesses. Used vehicle departments contribute significantly to dealership profitability when properly managed, and are a primary source of financial liquidity. As a result, many new vehicle dealerships consider used vehicle sales essential for maintaining the ability to conduct new vehicle sales transactions.

The key processes of used vehicle department operations include the appraisal and purchase of used vehicles for stock. Further, the maintenance of current inventory to ensure maximum gross profit and original equity is important for optimal business performance. Finally, the management of used vehicle sales transactions is necessary to ensure meeting business objectives.

The used vehicle department has a number of inherent vulnerabilities. The used vehicle marketplace is highly volatile. The wide variety of new vehicle makes and models presents a challenge even to seasoned appraisers and salespersons in obtaining current valuation information and making accurate appraisals. The widespread use of transitory new vehicle incentives causes disruptions in the marketplace. Consolidation of ownership causes separation of key stakeholders from used vehicle department decision making.

There are typically multiple managers authorized to make key decisions on appraising, purchasing and selling used vehicle inventory. At any given time, not all managers will have up-to-date information or expertise. Further, the environment surrounding appraising, buying and selling is often charged with emotion, which adds another layer of complexity to decision making processes. As a result, objective assessment of a vehicle purchase or sale is made difficult and the real value of a transaction is obscured by factors other than the financial and operating objectives of the dealership. In many cases, the customer feels that a better deal for a similar automobile exists at another dealership, but that information is difficult to obtain.

The used vehicle department also has a number of weaknesses not addressed by present methods. For example, there is limited accountability for key decisions. Key decisions, for example, purchasing, stocking and disposition are made with individual skills, experience and judgment and often without support of empirical information. There are frequent internal and external opportunities for fraud. There exists a minimal amount of usable technology and/or business intelligence to support decision making at several levels of operation and accountability. Further, there is little opportunity to properly report to customers how the current offer compares to other offers in the marketplace, and very little direction for marketing to customers, including generating rich, customizable descriptions, and monitoring specific customers' interest. With respect to business technology and intelligence, used vehicle operations have, to a large extent, resisted integration with electronic valuation information, for example, and have continued without the benefit of the most current supporting information and/or technology.

There is a demand for a system and method that provides relevant information in a current time frame, builds strategy awareness, and provides accountability for a used vehicle department. Further, there is a need to generate rich, customizable descriptions of the goods; report comparable offers to customers; properly market the products for sale; and to some extent monitor the customer's interest in purchasing the product. The present invention satisfies the demand.

### SUMMARY OF THE INVENTION

There are, in view of the above and other reasons, numerous opportunities to improve the performance of used vehicle departments, especially by effectively and efficiently pricing a used automobile to reduce the amount of time to sell that vehicle, to increase the amount of profit from that vehicle, or, in some cases, both of these.

The system and method of the present invention contemplates working in conjunction with and enhancing the vehicle appraisal system set forth in U.S. patent application Ser. No. 11/332,935, titled “System and Method for Managing Business Performance,” which is incorporated by reference herein. The present invention provides a competitive pricing tool for dealers so that they can more efficiently and effectively price their used vehicles. The present invention requires cutting edge Internet harvesting technology, to gather detailed Internet data. A proprietary harvesting system has been developed and deployed for more specific functionality.

The preferred embodiment of the present invention is a proprietary ranking system that recognizes a relationship between the mileage on a used vehicle and the asking price in order to “rank” competitive vehicles. The purpose of the ranking is to simulate the consumer's mental process of narrowing and prioritizing a wide range of generally similar vehicles into a manageable “shopping list”. Although the used vehicle's mileage is one variable, the invention contemplates additional factors in the ranking formula (for example, trims, distance, and specific equipment such as navigation systems).

Further, the present invention may include similar functionality for new vehicles, recognizing other variables, such as the MSRP. Additional functionality of the present invention includes the tracking and comparing of the final sale price for a vehicle with its initial asking price. The present invention will track and monitor the interval at which unique vehicles become available for sale, have price modifications, and are removed from the market. With this tracking, reports can be generated for management detailing the discount from the initial Price as well as market trends including “days supply” of “uniquely configured vehicles”, and the expected number of “days to sale” at any given price point.

Further, the present invention introduces functionality called “vMax” that automatically maximizes the asking price based on any selected “effective vRank” or “vRank”. The vMax functionality finds the highest possible price while maintaining a pre-selected market rank position, i.e., vRank or effective vRank. A user can use the vMax functionality to determine the optimal price for a given vehicle, recognizing its current market position with respect to its competitors, and the strategic value of that position. The user has the ability to have the vMax functionality automatically set prices for its used inventory. Further, the vMax functionality will serve as the foundation for developing, setting and implementing internal and/or an internet pricing strategies for at least one used vehicle in inventory.

The invention includes configurable pricing models. These models allow the application to recommend specific vehicle prices based on the variety of user selected parameters including but not limited to: desired gross profit, inventory turn, and days supply.

The invention includes a method that will track the attributes that users select to define the profile of competitive vehicles. Using proprietary algorithms based on factors such as, but not limited to, frequency and geography, the system will automatically redefine competitive vehicle profiles for similar prospective analysis. These automatically generated competitive vehicle profiles are called “default profiles”.

The present invention allows dealers to use the pricing tool to “operationalize” a pricing strategy. Initially, pricing strategies would be based on, for example, the grid shown below as a function of % of market and age.

| Age (in days) | 0-10 | 11-20 | 21-30 | 31+ |
|---|---|---|---|---|
| Price | % market | % market | % market | % market |
| (as a % of market) | | | | |

The present invention includes a pricing strategy that would also be formulated as a function of other variables such as rank, score, or days supply. Therefore, the pricing plan utility will utilize other such pricing strategies.

In order to operationalize a pricing strategy, two numbers need to be added to the “List Price” column for each vehicle. Under the “List Price”, the present invention also has “Plan Price”, and “Difference”. The “Plan Price” would automatically fill for dealers with an “operationalized” pricing strategy according to the dealership's set strategy. The “Difference” would also automatically fill as the difference, in dollars, between the “List Price” and “Plan Price” for that vehicle. For those dealerships without an operational plan, the “Plan Price” and “Difference” would be blank.

A dealer must be able to either “disregard”, “accept” or “override” the “Plan Price.” Therefore, the “Plan Price” will need to display differently to distinguish whether it is still a proposed “automatic fill” entry based on the pricing strategy (which is recommended), an accepted automatic fill plan price, or a “override” entry. The purpose of displaying each of these three price conditions differently is to identify whether a plan price was determined automatically and not approved (recommended), determined automatically and “approved”, or plan price override or manually entered. Accepted and override price changes (2 and 3 above) should flow into the daily updated change report.

There are a number of effective and efficient ways of accepting or overriding a “Plan Price.” Until a dealer accepts any price change and, subsequently, the dealership's DMS/internet has been updated to incorporate the change, there will be a “Difference” between the “Plan Price” and the “List Price”.

For dealers with an operationalized pricing strategy, the “Plan Price” will update automatically to a new “Plan Price” (recommended) when the vehicle has an event (like a birthday with an aged based plan) which moves it into a new price category.

The default sort upon opening the pricing tool to the inventory page for dealers with a pricing strategy will be “Difference”, highest to lowest. This will allow a user to immediately focus on which vehicles in inventory are not priced in line with the dealership's strategy, either because a manager has not accepted a price change or because the DMS/internet has not been properly updated.

As previously mentioned, the present invention measures and quantifies the day's supply of a uniquely configured vehicle in the marketplace. Using day's supply data, the method will include the functionality to model the relationship between the day's supply of a uniquely configured vehicle and its retail price such that at any given price point, the model will be able to quantify or predict how many days it will take for the given vehicle to sell.

Another objective of the present invention is that a user will have the ability to input at least one price and dynamically obtain the number of “days to sale” for such vehicle at that given market price. Similarly, a user will have the ability to input the desired days to sell for at least one uniquely configured vehicle in order to dynamically obtain the retail price required to obtain this sales objective. In addition, this invention contemplates the ability to model price sensitivity to other variables including but not limited to days supply.

Another objective of the present invention includes an appraisal module which embodies a variety of traditional third party valuation guide data sets. Examples include but are not limited to: wholesale auction transactions, Kelley Blue Book, Black Book, NADA guidebook, and Galves. In addition, the invention includes a novel approach to viewing the retail market value for any vehicle contemplated for purchase. This approach includes information displayed in a similar format to that referenced in FIG. 18. In addition, the appraisal module will contain another method of assessing the relationship among the proposed acquisition amount, the dealership's “goals”, and the present retail market/wholesale market. A representation of this is shown in FIG. 19, or “vAuto four square.”

Another objective of the present invention provides detailed information to the potential customer about an automobile for sale, including information relating to other similar automobiles for sale in a particular geographical area. This allows the customer to comparison shop and determine the validity of the current offer. The customer will have the ability to access this information at the point of sale (the car dealership) or at a later time and place such as the customer's mobile phone or home computer, etc. The dealership will be informed each time the customer accesses the information, which indicates the level of interest of the customer, thereby aligning the sales process, and in particular the price delivery system for the dealer, with the novel transparency to a customer.

Another objective of the present invention provides a stocking tool, which compares a dealership's used vehicle inventory stocking profile to that of sales in the dealer's market by identifying supply and demand for each vehicle at a year, make, model, and trim level. This stocking tool quantifies the number of each uniquely configured vehicle that is available and compares it to the current available supply. In the preferred embodiment, the user can query the market using a stocking objective slider bar to identify vehicles that are selling in the highest volume, lowest day supply, or balanced by both criteria. Besides using a slider bar, other methods can be used to identify relevant vehicles to achieve the same results. Additionally, the present invention compares dealer's current inventory to market sales data by vehicle segment according to price class. Once a dealer determines the vehicles that need to be purchased for inventory, they can be automatically transferred to a buy list. In accordance with the preferred embodiment of the present invention, the system will consider dealer's present stock and past sales to derive a quantity to be purchased to meet the stated stocking objective and the dealer can then view currently available vehicles for sale that match those which need to be purchased and take any action necessary to obtain the vehicles. Actions include, but are not limited to automatically submitting a wholesale purchase request to the selling dealer or private party.

Another objective of the present invention provides a virtual view or merchandising view of how well each vehicle is being represented on any advertised sites, i.e., a quick snapshot as to the completeness and correctness of each vehicle's information as advertised on-line or otherwise. In accordance with the preferred embodiment of the present invention, the dealer can inspect the virtual inventory vehicle-by-vehicle to determine the actions to be taken to present a sharper image of the merchandise for sale. The preferred embodiment of the present invention provides a summary of what the dealership inventory looks like on the websites, for example, thus allowing the dealer to track the advertisements anytime and view how the advertisement has been displayed in an internet shoppers search. Additional information can be obtained, such as anytime a shopper drills down on an initial add to view specific pictures or descriptions, allowing the dealer to determine how effective the dealership has been at merchandising its inventory. Using this information for example, the list price history can be tracked as it corresponds with the number of page views, assisting in identifying the sweet spot or the price-point where the reduced price affords the most page views but still allows for the optimal gross. Additional information can be obtained, including the number of views, the time on the website, or on a particular page on the website; providing the dealer with a virtual marketing and advertising scorecard.

Another objective of the present invention provides an automatic writing tool for the dealer to be able to use to properly market any of the automobiles being offered for sale. The technology allows the dealer to emphasize the unique attributes of each car and generate automatically compelling descriptions that can be modified as needed.

The detailed description of the invention herein is intended to merely be an example and is in no way intended to limit the scope of the invention to this example. Accordingly, modifications to the description are possible, and it should be clearly understood that the invention may be practiced in many different ways than the example specifically described herein, and still remain within the scope of the invention and the claims.

### BRIEF DESCRIPTION OF THE DRAWINGS

While the claims concluding the specification particularly point out and distinctly claim the precise subject matter regarded as the sum and substance of the present invention, its construction and composition may be best understood from the following detailed description taken in connection with the accompanying drawings, in which:

FIG. 1 shows the main view of a system according to one embodiment of the present invention;

FIG. 2 shows one embodiment of a system according to the present invention;

FIG. 3 shows a view of the system according to one embodiment of the present invention;

FIG. 4 shows a detail view of a system according to one embodiment of the present invention;

FIGS. 5A and 5B show the drop down views of a system according to one embodiment of the present invention;

FIG. 6 shows a detail view of the system according to one embodiment of the present invention;

FIG. 7 shows a supply trend chart according to one embodiment of the present invention;

FIGS. 8A and 8B show a notification view of the system according to one embodiment of the present invention;

FIG. 9 shows a price change approval view of the system according to one embodiment of the present invention;

FIG. 10 shows a competitive set profile view of the system according to one embodiment of the present invention;

FIG. 11 shows a profit profile view of the system according to one embodiment of the present invention;

FIG. 12 shows a pricing overview of the system according to one embodiment of the present invention;

FIG. 13 shows a daily summary report of the system according to one embodiment of the present invention;

FIG. 14 shows a yellow car report of the system according to one embodiment of the present invention;

FIG. 15 shows a dealer's report of the system according to one embodiment of the present invention;

FIG. 16 shows a vehicle data entry page of the system according to one embodiment of the present invention;

FIG. 17 shows a dealership current inventory report of the system according to one embodiment of the present invention;

FIG. 18 shows a stock item report of the system according to one embodiment of the present invention;

FIGS. 19A-C show an alternative method of displaying and assessing the relationship among the acquisition amount, dealership goals and the present retail market;

FIG. 20 shows a table modeling the relationship between the days to sell of a vehicle and its retail price according to one embodiment of the present invention.

FIG. 21 shows a stock item report of the system according to another embodiment of the present invention;

FIG. 22 shows a chart and pie graph demonstrating the days in inventory ranking summary according to one embodiment of the present invention.

FIG. 23 shows a schematic drawing of the computer system according to one embodiment of the present invention;

FIG. 24 shows a screen shot of the Price Tool window according to one embodiment of the present invention;

FIG. 25 shows a screen shot of the Investment Summary window according to one embodiment of the present invention;

FIG. 26 shows a screen shot of the Appraisal Summary window according to one embodiment of the present invention;

FIG. 27 shows a screen shot of the dealer's inventory according to one embodiment of the present invention;

FIG. 28 shows a screen shot of the Vehicle Detail window according to one embodiment of the present invention;

FIG. 29 shows a screen shot of the Pending Price Report according to one embodiment of the present invention;

FIG. 30 shows a screen shot of the Competitive Set according to one embodiment of the present invention;

FIG. 31 shows a screen shot of the Appraisal window according to one embodiment of the present invention;

FIG. 32 shows a screen shot of the Inventory Stocking Summary window according to one embodiment of the present invention;

FIG. 33 shows a screen shot of the Heat Sheet window according to one embodiment of the present invention;

FIG. 34 shows a second screen shot of the Heat Sheet window according to one embodiment of the present invention;

FIG. 35 shows a screen shot of the Buy List window according to one embodiment of the present invention;

FIG. 36 shows a screen shot of the Stocking Report or Live Market View window according to one embodiment of the present invention;

FIG. 37 shows a screen shot of the Real Deal Report window according to one embodiment of the present invention;

FIG. 38 shows a screen shot of the Real Deal Report window according to one embodiment of the present invention;

FIG. 39 shows a screen shot of the Real Deal Report window according to one embodiment of the present invention;

FIG. 40 shows a screen shot of the Virtual View window according to one embodiment of the present invention;

FIG. 41 shows a screen shot of the AutoWriter window according to one embodiment of the present invention.

### DETAILED DESCRIPTION OF A PRESENTLY PREFERRED EMBODIMENT

### The Main View Function

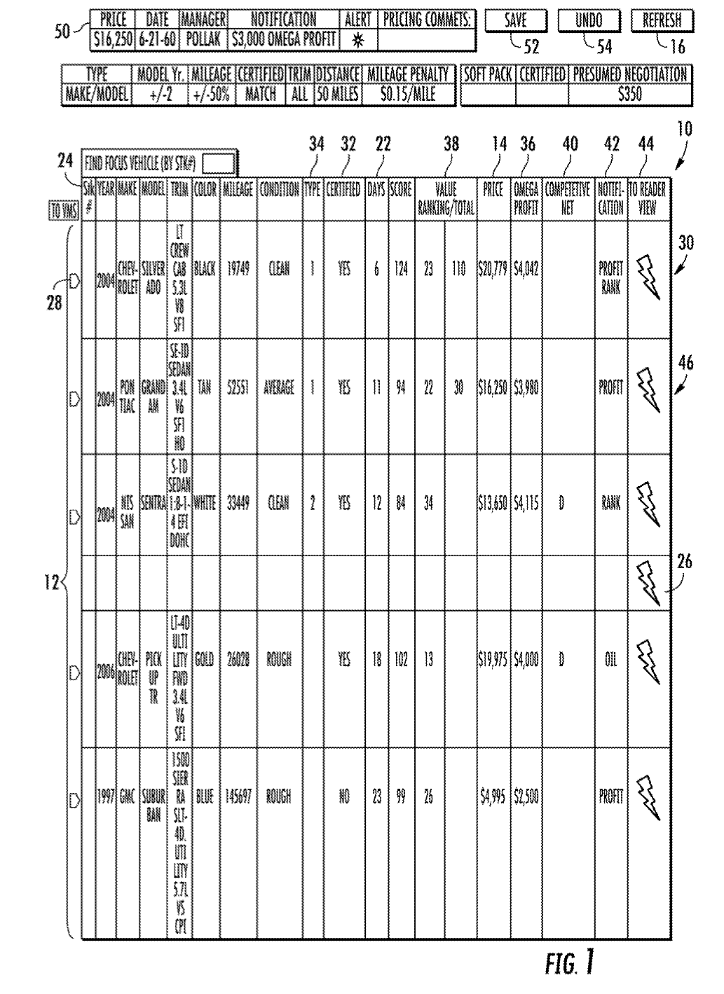

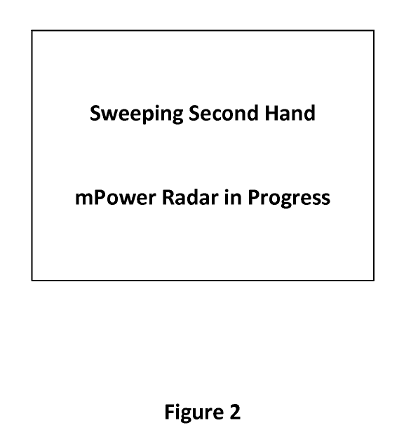

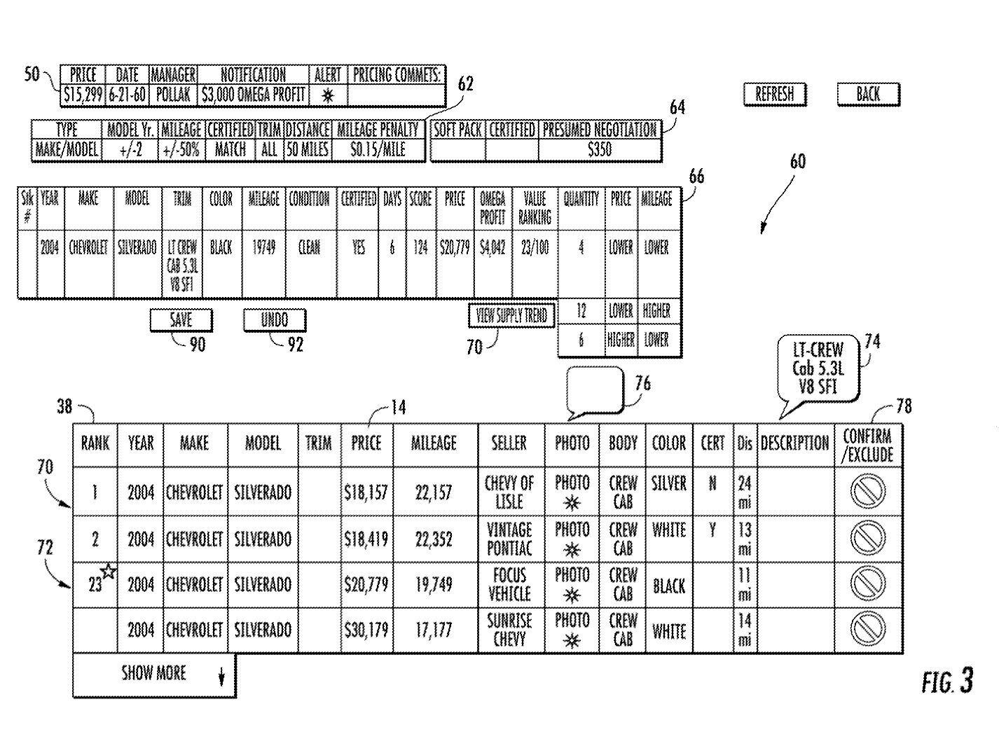

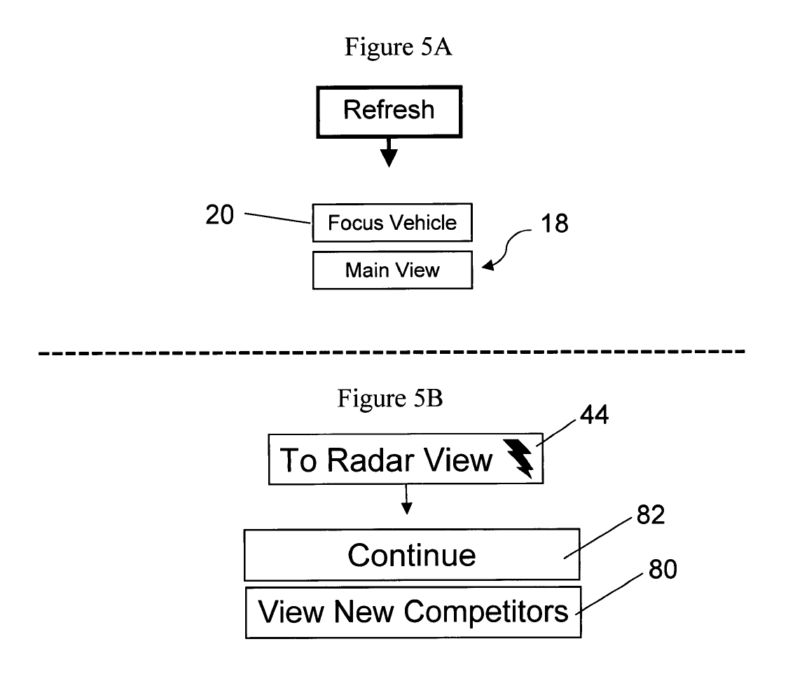

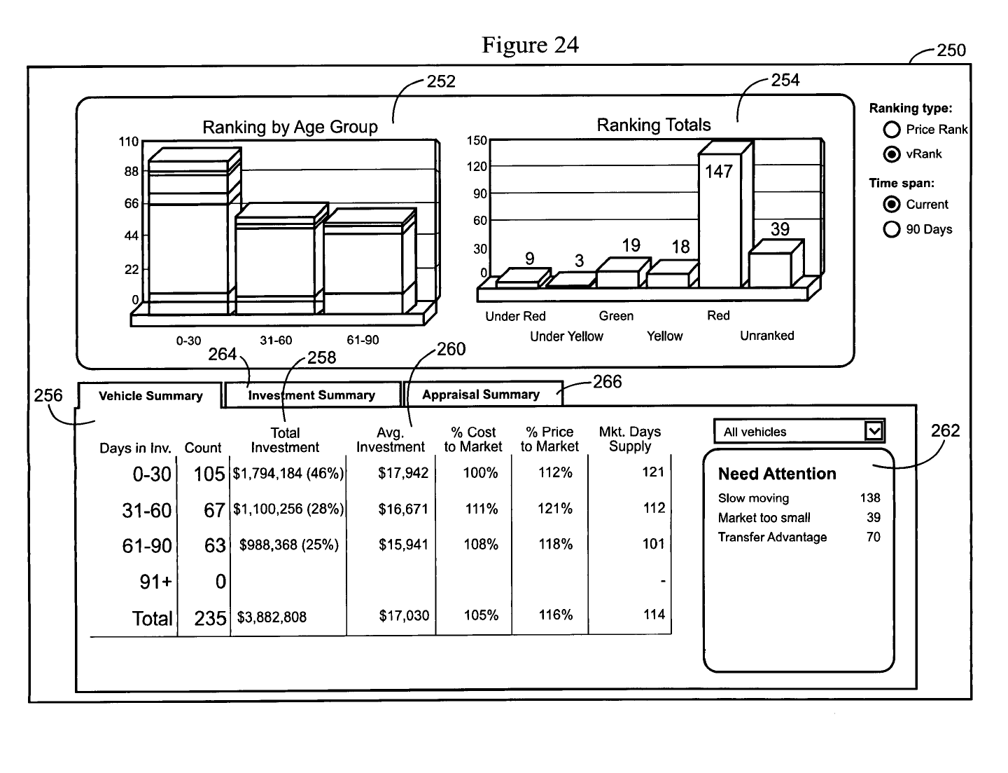

The present invention is web-based and therefore easily accessible for the user, i.e., the automobile dealer, over the Internet, for example. FIG. 1 shows an example of a Main View grid 10 that a user will see once logged into the system of the present invention (FIGS. 24 through 31, as described in detail herein, show screen shots of the preferred embodiment). Among other things, the grid 10 will display current inventory 12 and pricing information 14 updated from both the DMS and a proprietary program, Automated Radar Scan, which as described herein, harvest or gathers necessary vehicle data from various locations on the Internet. This data will automatically update daily. In addition, a user can request a manual refresh, which will provide the current data at that time. The user can select the Refresh button 16 from the Main View menu 10 to receive the Refresh drop-down menu 18 (shown in FIG. 5A). The user can enter information for a particular vehicle 20 and the results will be updated automatically.

The Main View grid 10 will initially display vehicles 12 in order of days 22, freshest to oldest. This screen can be sorted by days 22, or any other variable, and printed accordingly. The present invention provides an easy method of instantly placing focus on a particular vehicle 12, the focus vehicle, using the stock number 24 as an identifier. On the Main View 10, there are two types of data, defaulted and modified. There is a clear visual indication that denotes whether or not a vehicle has been modified, or that vehicle specifications have been entered. The Main View 10 will highlight vehicles, for example in red 26, that have not been modified. These vehicles can be modified by clicking on the pencil icon 28 located to the left of each data row 30, which will connect the user to the current Auto Vehicle Maintenance Screen (as described in U.S. patent application Ser. No. 11/332,935). Modifying the Vehicle Specifications will automatically update the Main View screen 10 on the system of the present application.

The Main View 10 will show additional fields of data for each vehicle. Specifically, there will be fields denoting whether or not a vehicle is certified 32, its type 34, its price 14, its Omega Profit 36, a Value Ranking 38, a Competitive Set Indicator 40, a Vehicle Notification Indicator (on/off) 42, as well as a Radar Link 44. Also, if the Vehicle Notification is on Alert, that vehicle row will be shaded yellow 46, for example, denoting a Yellow Car. The Omega Profit 36 and Competitive Set Indicator 40 fields may also be shaded 48 to indicate that a user has manually overwritten the default settings. This shading is necessary to denote overrides when the screen 10 is printed for use in paper form.

When a focus vehicle is designated, the cursor will move to highlight this vehicle. The Main View 10 will then display the following detailed information at the top of the screen 50, corresponding to the focus vehicle: the Update Detail, the Competitive Set Bar 40, and the Omega Profit Bar 36. This information will dynamically “fill” and populate with a focus vehicle's details as the cursor moves over the Main View 10. Users will be able to test various scenarios by modeling Price 14, Value Ranking 38 and/or Omega Profit 36 while in the Main View 10.

Once a new value is entered, all other dependent fields will dynamically update and recalculate accordingly. Users can also override the Default Competitive Set Profile 40 as well as the Default Omega Profit Profile 36 from the Main View 10. Once a new profile is entered, all other dependent fields will dynamically update and recalculate accordingly. Changes will not be saved until the user clicks the SAVE button 52. As described in more detail below, this functionality will permit a user to model various pricing scenarios. The user will be prompted to SAVE 52 or UNDO 54 after modeling one vehicle, before beginning on another, or exiting the application.

FIG. 3 shows the Radar View function 60. In the Radar View 60, as well as in the Main View 10, values can be overwritten and modeled. The Main View 10 reflects any modeling and/or overriding that is done on the Radar View 60 as the Radar View 60 reflects any modeling and/or overriding that is done on the Main View 10. In other words, the user is able to move seamlessly between the Main View 10 and the Radar View 60.

### The Radar View Function

The Main View 10 will link, by vehicle, to both the current Auto Inventory Maintenance screen using the pencil icon 28, as well as linking to the Radar View 60 by clicking on the Radar Link 44.

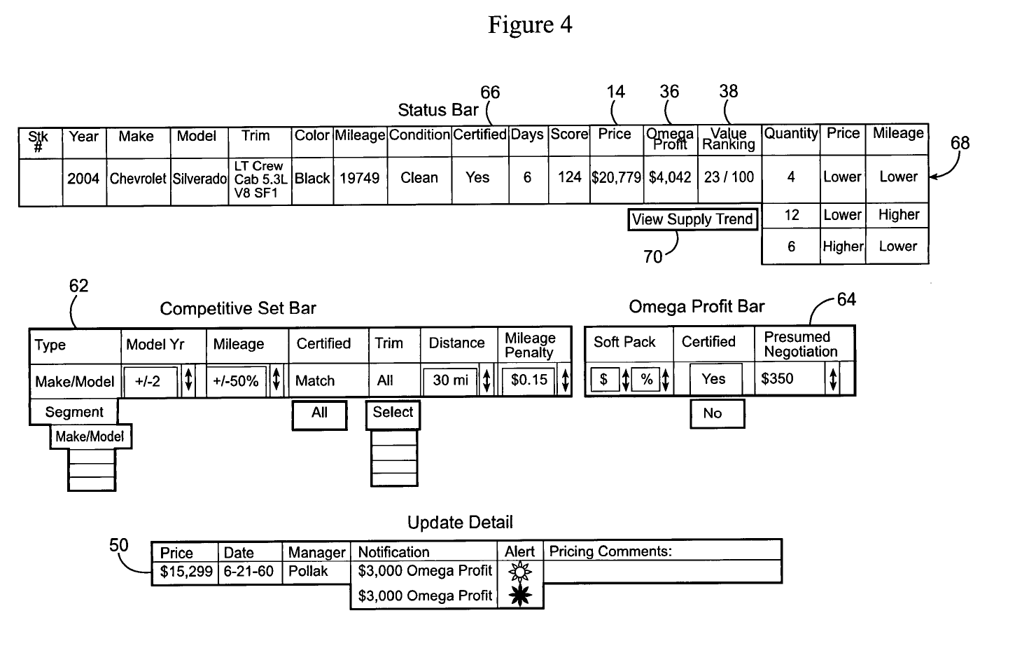

FIG. 3 shows the Radar View 60. When a user is modeling a price 14, it is helpful to understand the pricing of competitive vehicles. Specifically, the user may want to understand what vehicles are ranked ahead of their focus vehicle according to Value Ranking 38. The Radar View 60, when opened, displays the Update Detail 50 for the focus vehicle (see FIG. 4 for the Radar Detail). The Radar View 60 also displays the Competitive Set Bar 62 and the Omega Profit Bar 64 for the focus vehicle (see FIG. 4 for the Radar Detail), along with a Status Bar 66 for the focus vehicle, including Competitor Grid 68 and a link to View Supply Trend 70 (see FIG. 4 for the Radar Detail); and the Competitive Set 40.

The Competitive Set 40 will display relevant descriptions, by row, of the vehicles ranked as the focus vehicle's competitors. The Competitive Set 40 is listed by Value Ranking 38, from lowest to highest. The Radar View 60 will display at least 10 competitive vehicles at a time. The user will be able to scroll down to view more competitors as needed. The focus vehicle (72 in FIG. 3) is contained in a row of its own and is shaded to denote that it is the focus vehicle, as well as being displayed on the Status Bar 66. From this list the user can verify a competitive vehicle's relevance by “seeing” its description 74 and a photo 76 of the vehicle, as the cursor moves across a row. These details will populate “dialog-type” boxes above the list.

In addition to providing detailed information about a competitor, each row contains a Confirmation/Exclusion field 78. A vehicle can be excluded from the competitive analysis should a user decide that it is not relevant for the purposes of considering price 14 or Value Ranking 38. An Excluded Vehicle 78 will no longer be ranked and will no longer affect the competitive position of the focus vehicle 72. The excluded vehicle 78 will drop to the bottom of the list of competitors and will be shaded in gray to indicate that it has been excluded from the competitive set 40. At any time, a user can update the Confirmation/Exclusion 78 field to “re-include” a vehicle. All relevant values will update accordingly.

When the user opens the application or system at a later date or time, the Radar Link 44 will prompt the user to either “Continue” directly to the Radar View 60, or to “View New Competitors” 80 (see FIG. 5B for the Radar Link Drop-Down). If the user chooses to “Continue” 82 directly to the Radar View 60, new competitors will be included in the Competitive Set 40, according to their Value Rankings 38. The confirm/exclude icon 78 will be shaded orange to indicate that the user has not yet evaluated the vehicle.

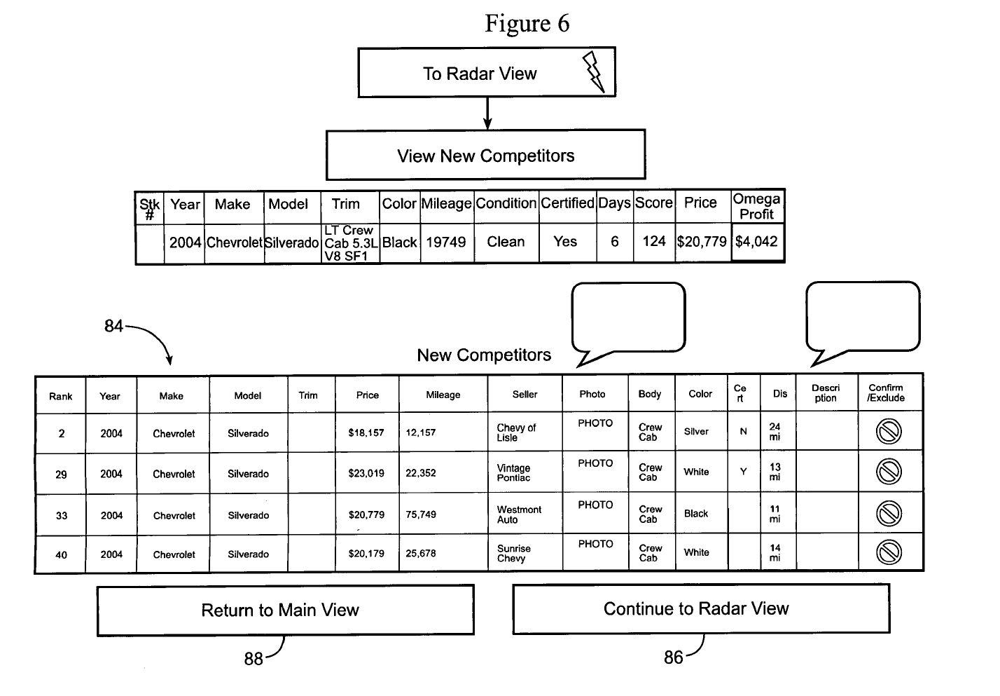

If the user accepts the prompt to “View New Competitors” 80, the user will be directed to the New Competitor View screen 84 which displays only those competitive vehicles that have not been previously viewed by a user and, consequently, have neither been confirmed or excluded from the analysis. FIG. 6 shows the New Competitor View screen 84. This new competitor feature allows a user to immediately update the list of “included” versus “excluded” competitors. Should the user decide to exclude a vehicle, as previously described, this vehicle will be highlighted in gray and moved to the bottom of the competitive list. To the extent that a vehicle has been excluded from the analysis, it will remain excluded should the application be refreshed or used again at a different time.

Once a user has finished evaluating the New Competitors, the user can select the “Continue to the Radar View” button 86 or “Return to the Main View” 88.

As on the Main View 10, the user can also model Price 14, Omega Profit 36, and Value Ranking 38 on the Radar View 60 and all dependent variables will dynamically update. This is done from the Status Bar 66, the Competitive Set Bar 62 and the Omega Profit Bar 64, and not from the Competitive Set 40. The list of competitors is only interactive with respect to including or excluding vehicles. Consistent with the functionality of the Main View 10, the user can override a Default Competitive Set Profile and/or a Default Omega Profit Profile from the Radar View 60, and the screen will repopulate with the appropriate list of competitors. Changes will not be saved until the user clicks the SAVE button 90, as described in detail herein. This functionality allows the user to model various pricing scenarios. The user will be prompted to SAVE 90 or UNDO 92 changes made before working on another vehicle or exiting the application.

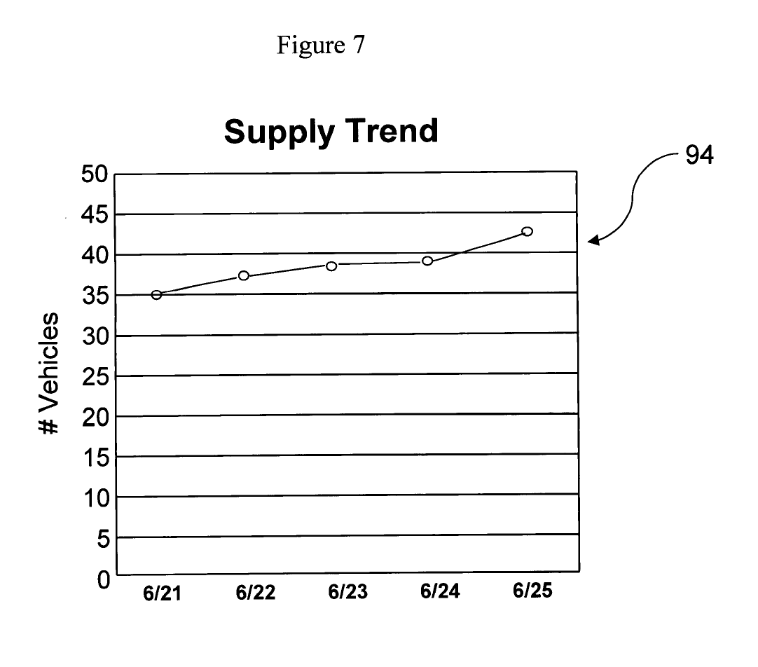

The Status Bar 66 on the Radar View 60 also provides a View Supply Trend link 70 to a Supply Trend Graph 94 that shows how the Competitive Set 40 size is changing over time. FIG. 7 shows an example of a Supply Trend graph 94. The Radar Application needs to automatically store the data needed to generate this graph 94, using daily values. The graph 94 should plot the total competitive set 40, before exclusions, for consistency.

The Radar View 60 can be sorted in the same manner as other data screens, and can be printed.

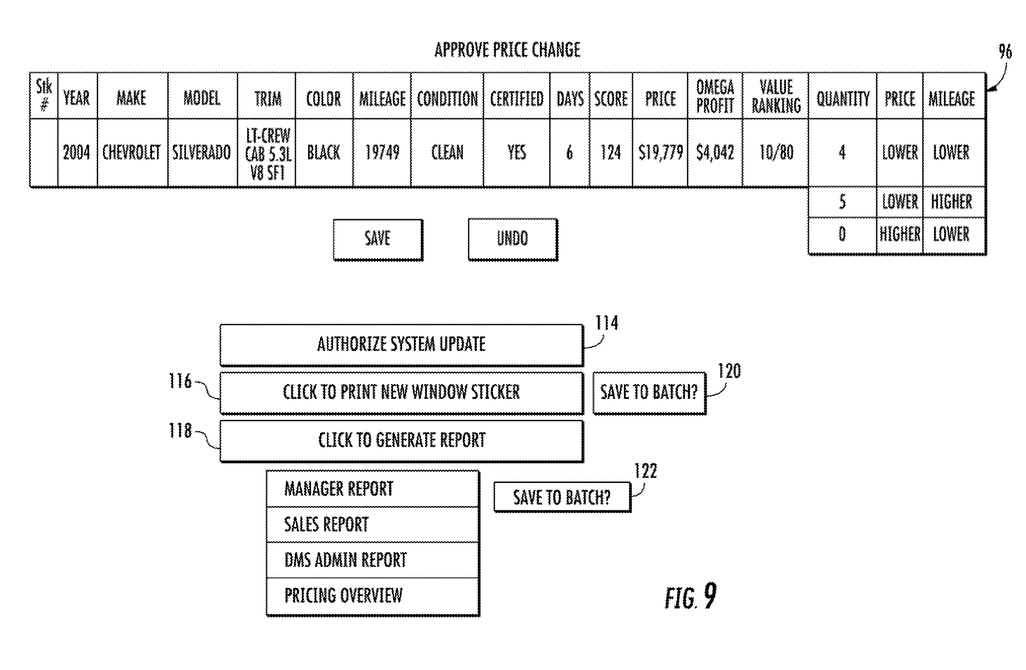

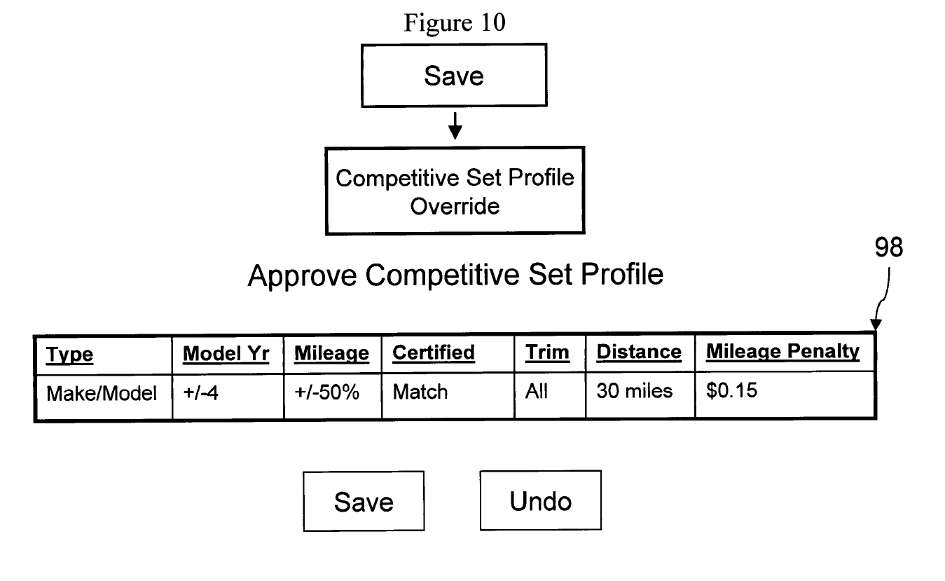

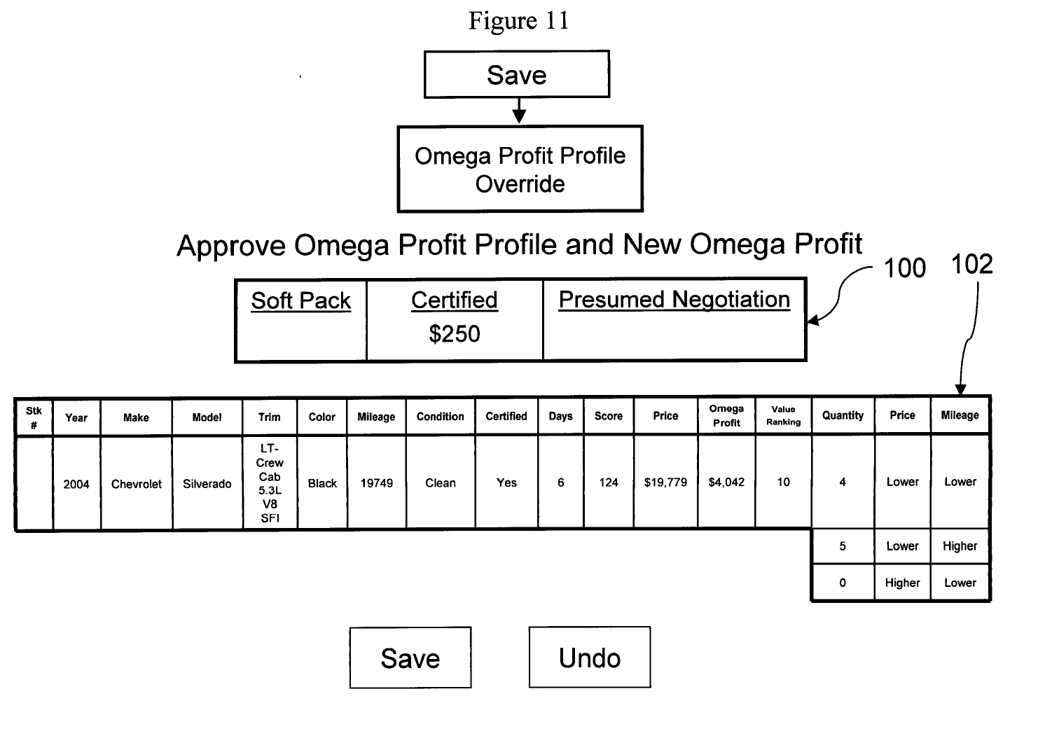

### The Save Feature

Wherever the user has the ability to model price 14 or override the Default Competitive Set Profile or Default Omega Profit Profile, there will be both a SAVE and an UNDO prompt. There is a unique visual recap for saving each type of change. Should a user wish to SAVE more than one type of change, for example, a Price 14 and a new Competitive Set Profile 40 or a Price 14 and a new Omega Profit Profile 36, the user will receive a visual recap for each change. Specifically, FIG. 9 shows a price change 14, where the user is asked to verify the new Status Bar 96. FIG. 10 shows that for a Competitive Set Profile 40 change, the user is asked to verify the new Competitive Set Bar 98. And FIG. 11 shows that for an Omega Profit Profile 36 change, both the new Omega Profit Bar 100 and the new Status Bar 102 (showing the new Omega Profit) must be verified by the user.

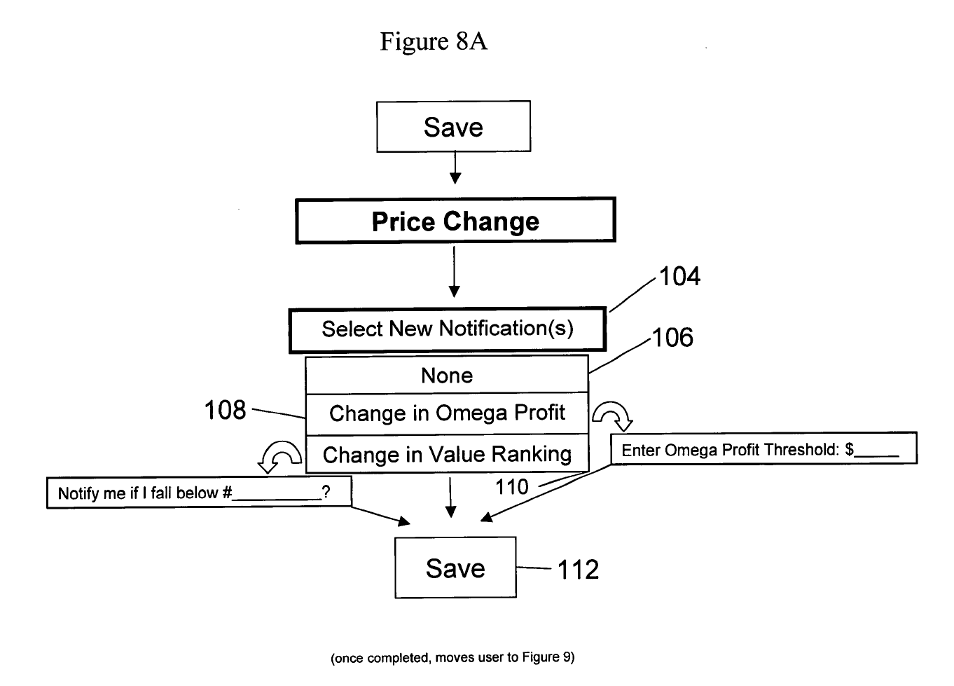

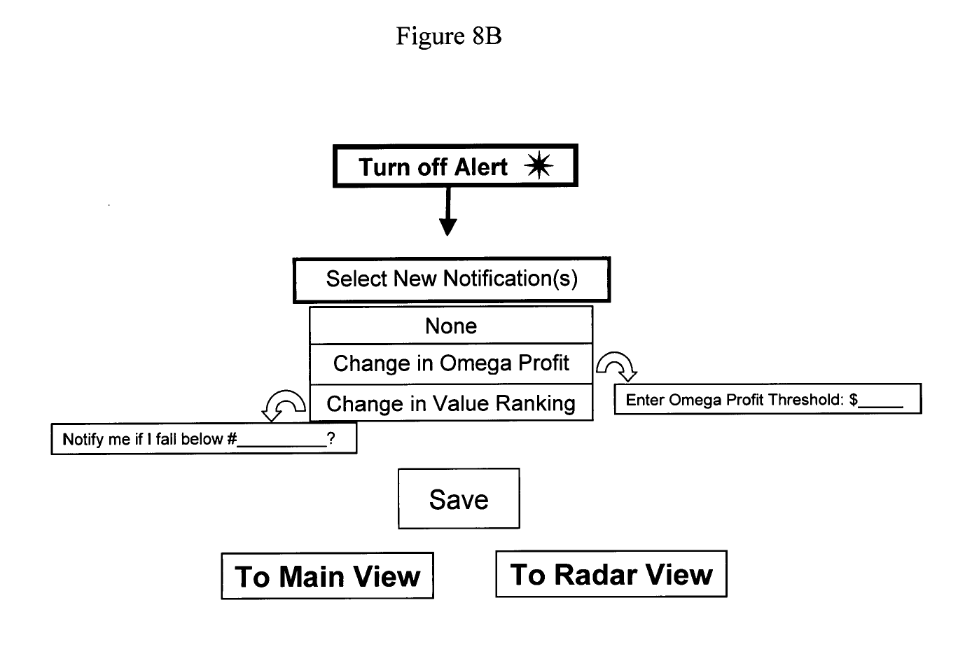

Before any change that affects Price can be SAVED, Vehicle Notification Options 104 will first be offered. These options will be presented in a series of drop-down boxes. FIG. 8 shows the Vehicle Notification Drop-Downs 106-110. A user can select “no notification” 106, an Omega Profit 108, and/or a Value Ranking notification option 110. The Vehicle Notification is in addition to, and not instead of, the Global Default Notification installed during the set-up/configuration of the application. After selecting a Vehicle Notification 104, the user will be directed to the SAVE feature 112 for Price Changes 96, as described above and shown in FIG. 9.

After the Vehicle Notification 104 options and price verification 96, the user will be prompted to update the system 114 for all price changes. When the user saves a price, they will have the option to designate one or more systems to update. The logins and passwords for these systems would be entered and saved by the users as part of the installation and set/up configuration procedure. The Radar Application is configured to send an automated message to a cost-effective, outsourced, labor center in order to generate the update as part of the SAVE function.

Additionally, as shown in FIG. 9, users will have the option to generate a new window sticker 116 reflecting the pricing change, and/or to generate any relevant reports 118. If a user is updating more than one vehicle, the user can request that the window sticker and/or report save to batch 120, 122 for later printing.

### The Reports Feature

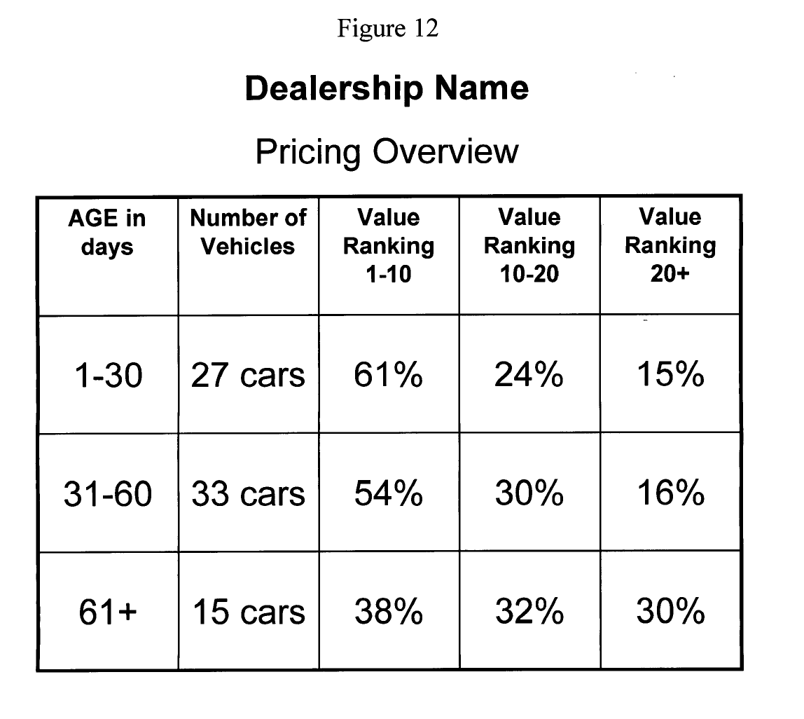

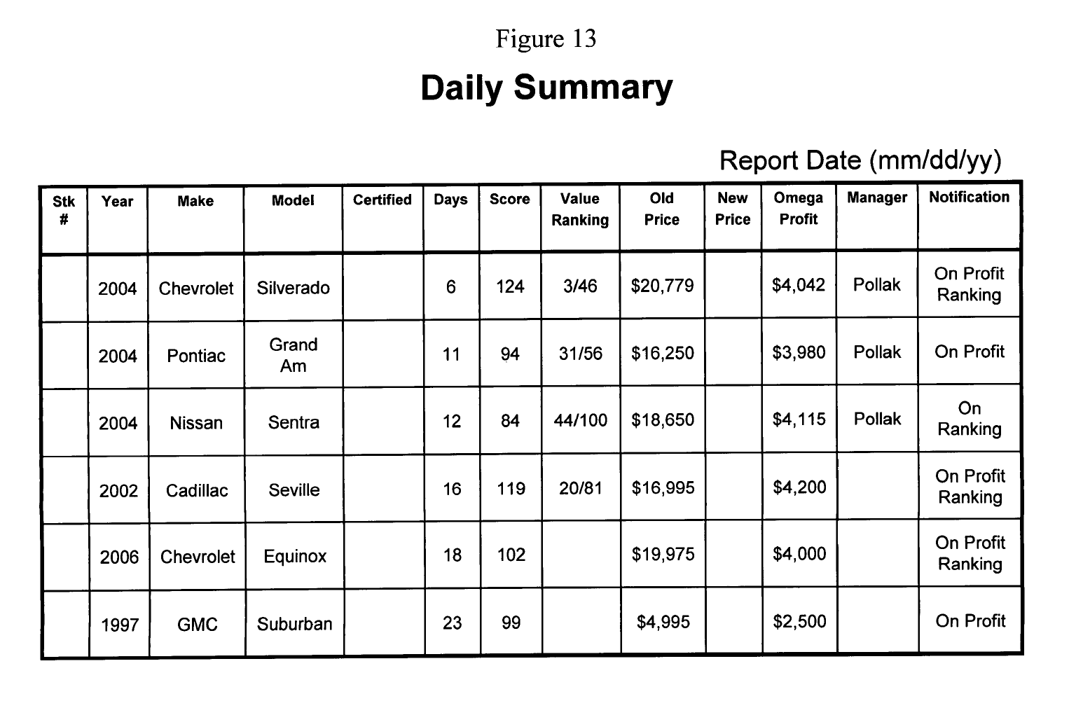

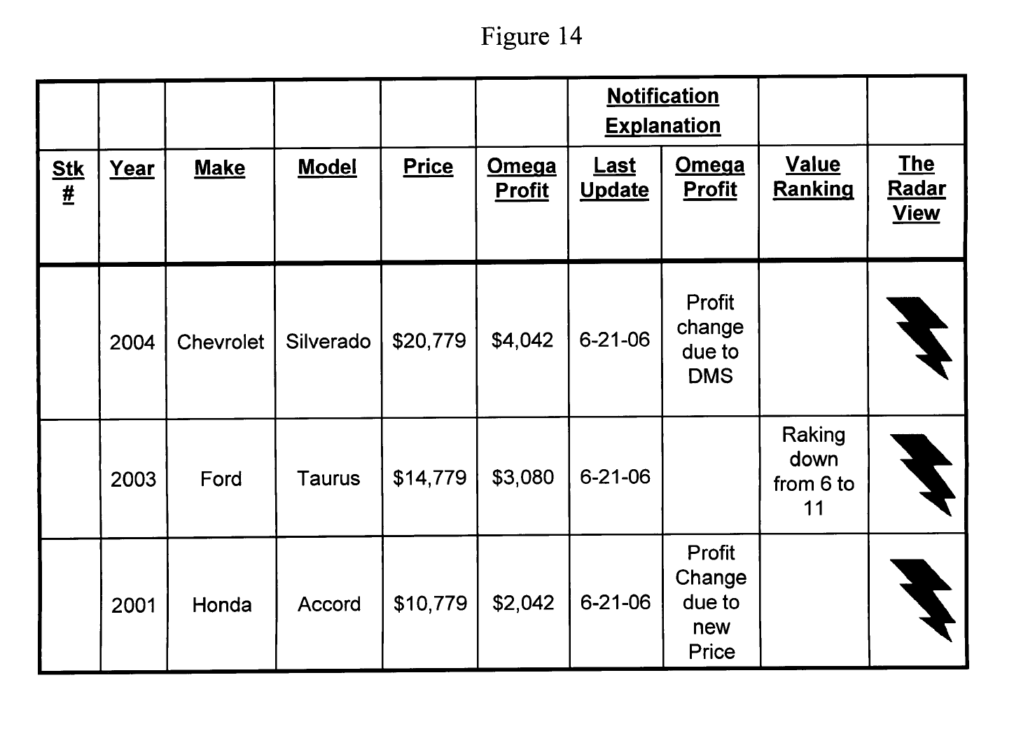

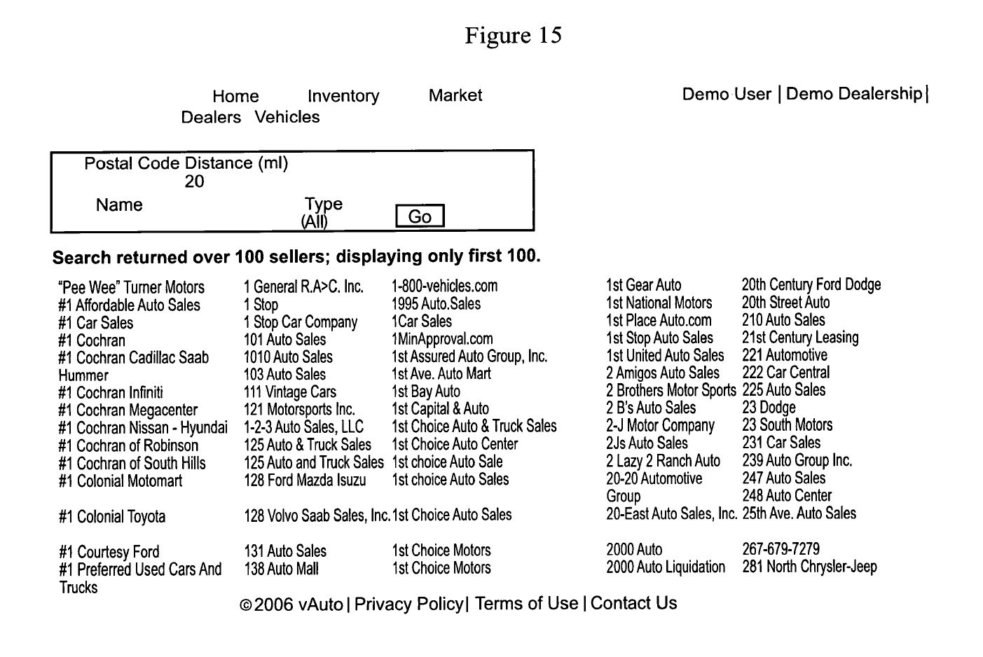

The Radar Application will be able to generate a variety of reports, including by way of example, Dealership Pricing Overview Report as shown in FIG. 12, a Daily Summary of Pricing Adjustments (by date) as shown in FIG. 13, a Yellow Car Report as shown in FIG. 14, a Dealer's Report as shown in FIG. 15, a Manager's Report (not shown) and a Salesperson Report (not shown). In addition as described in detail below, the present invention provides the ability to generate additional reports, such as Stocking Reports, Virtual View Reports, AutoWriter Reports and Real Deal Reports that contain timely information about other similar automobiles for sale in a specific geographic area and can be provided to the potential customer; accessible at the dealership or later by the customer outside of the dealership, and is to be used as a closing tool.

The Radar Application can also be accessed from the Auto Appraisal Screen in order for a manager of the dealership to view the competitive environment prior to completing the appraisal process. In this instance, the manager could view competitor's prices listed by Value Ranking 38 to help ascertain the appropriate value for optimal sale.

### The Radar Application

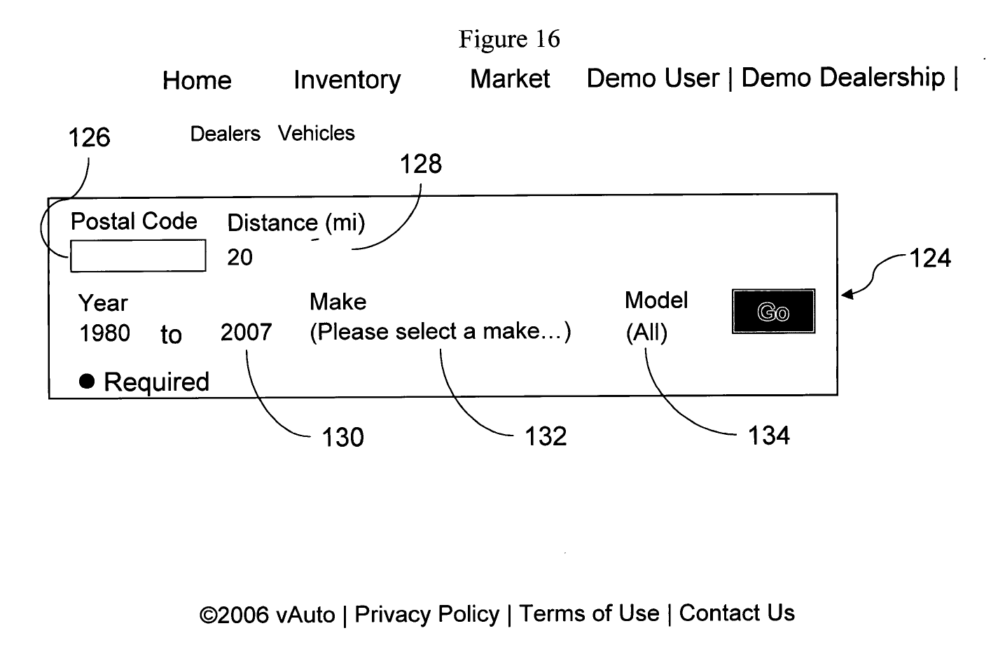

As shown in FIG. 16, once the system is populated with the necessary information using the harvesting technology described herein, the user can begin by accessing the Market Vehicles page 124. The user enters the postal code or zip code of the dealership 126, the distance from the dealership for the search 128, the year 130, make 132, and model 134 for the search.

Once this information is entered, the system will pull up a default configuration for the particular vehicle and establish a Value Ranking and an Effective Value Ranking for the dealer's vehicles in inventory. These rankings are based on similar vehicles, using the default configuration, however, the user can change the configuration, i.e., the engine type, trim, series, etc., in order to include or exclude certain vehicles from the ranking. This revised configuration can be done dynamically to show how differing the configuration varies the ranking. Further, these revisions can be stored and saved by the system so that at some point, the system will automatically change the default to match the most widely used configuration, or the competitive set.

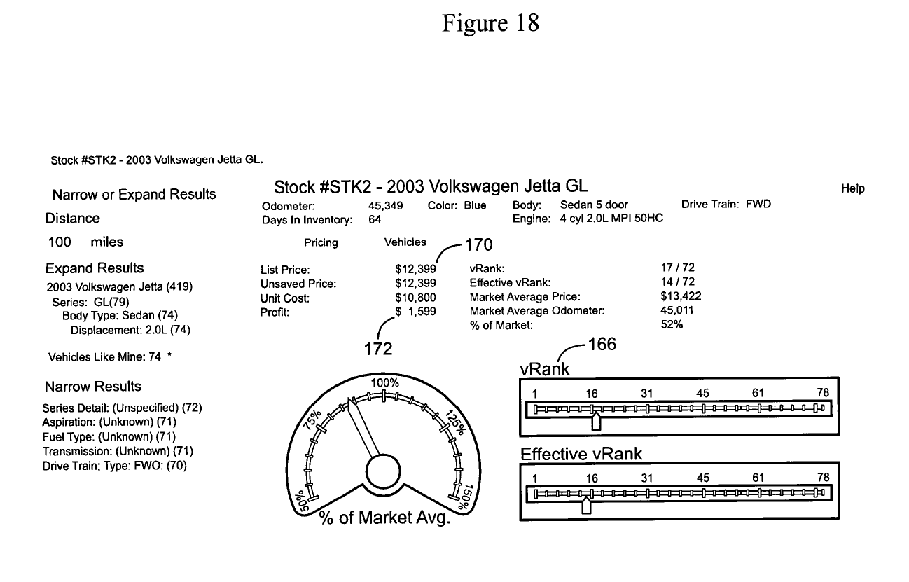

The Value Ranking 160 is determined by comparing the search results for all the vehicles for sale in the configuration. Once this information is obtained, the price of the focus vehicle is compared to all of the same vehicles in the search results and a number, based on price alone is generated. For example, as shown in FIG. 18, if 72 vehicles match the search, and 16 are priced lower and 55 are priced higher, the Value Ranking will be 17/72.

The Effective Value Ranking 162 is determined by taking into account the mileage each vehicle has and normalizing the price based on those miles. In other words, each vehicle is penalized for the miles is has been driven. However, a number of variables may be used to generate an Effective Value Ranking; for example, the condition of the car, standard and non-standard options, driving history, geographic location of car, whether or not garage kept, etc., can be taken into account when normalizing the vehicles.

Once each vehicle is normalized for miles (in this example), a new ranking, the Effective Value Ranking is established. In this example, if there were three vehicles with extremely high mileage, their Effective Value Ranking would drop when the normalization calculation took place. Thus, the focus vehicle would move from a Value Ranking of 17/72 to an Effective Value Ranking of 14/72 (see FIG. 18).

Also, a Value Score could be created based on the percentage of the asking price based on the mean of the Effective Value Ranking. So for example, if the mean effective asking price was $13,422 and the dealer or user was asking $12,399 for the vehicle, the Value Score would be 92% (see FIG. 18).

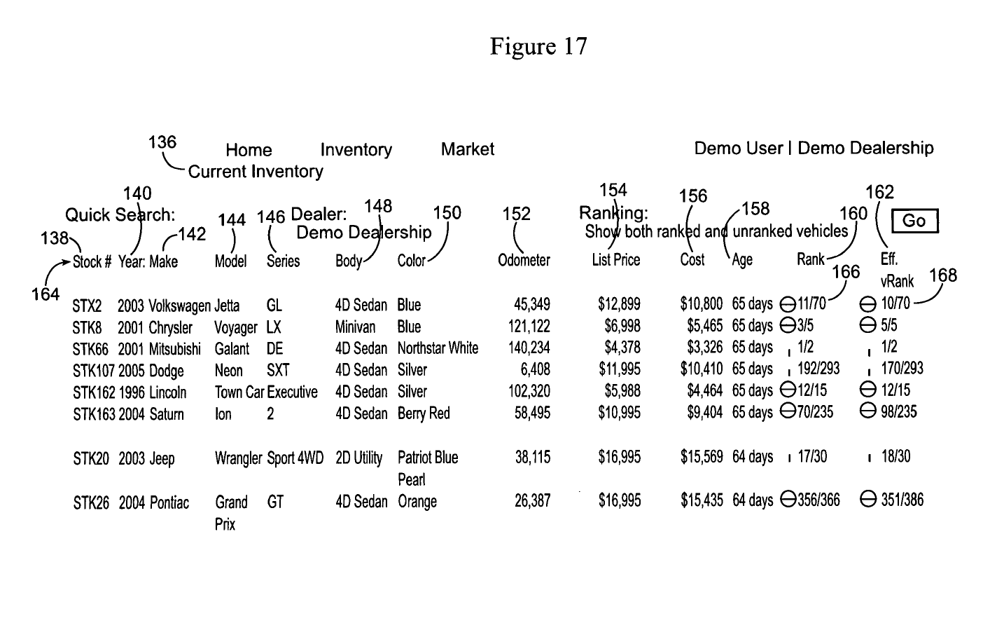

Once these calculations are complete, the user then can review a list of the dealership's current inventory 136, as shown in FIG. 17. The report displays all of the characteristics for each of these vehicles, including the stock number 138, the year manufactured 140, the make 142, the model 144, the series 146, the body type 148, the color 150, the mileage 152, the list price 154, the cost of the vehicle to the dealer 156 and the number of days on the lot 158.

The cost to market is the ratio of a dealership's unit cost compared to the average market retail price of a comparably equipped year, make, and model vehicle. It is calculated both on a per car basis and in aggregate.

The report also includes the Value Ranking 160 and the Effective Value Ranking 162. As described above, the Value Ranking 160 and the Effective Value Ranking 162 are determined from the results of the search of used vehicles (within the radius determined by the dealer). The rankings are based on price and mileage of the used vehicles for sale.

In the example on FIG. 17, the information pertaining to focus vehicle Stock No. 2 164 is listed in the first row. Stock No. 2 is a blue, four-door, 2003 Volkswagen Jetta GL with 45,349 miles. The vehicle is currently listed for sale a $12,399, cost the dealer $10,800, and has been sitting on the lot for 65 days. The system uses this information, along with the information obtained through its internet harvesting to determine that the Jetta's Value Ranking is 14/70 166. In other words, of the 70 Jettas being sold in the area, this particular Jetta has a Value Ranking of 14, based on price and mileage. Further, the Effective Value Ranking is 10/70 168.

FIG. 18 shows the display when the dealer selects the particular stock number, in this case Stock No. 2 164. The display shows all of the information from the previous inventory page, including the Value Ranking 166 and the Effective Value Ranking 168, however, the user can revise the selling price 170 of the vehicle and immediately obtain revised rankings. The system also calculates the profit as it is revised based on the selling price so that the dealer can take the changing profit 172 into account. This dynamic response allows the dealer to revise the selling price of the vehicle in response to other similar vehicles for sale to obtain the optimal selling price at the optimal profit margin.

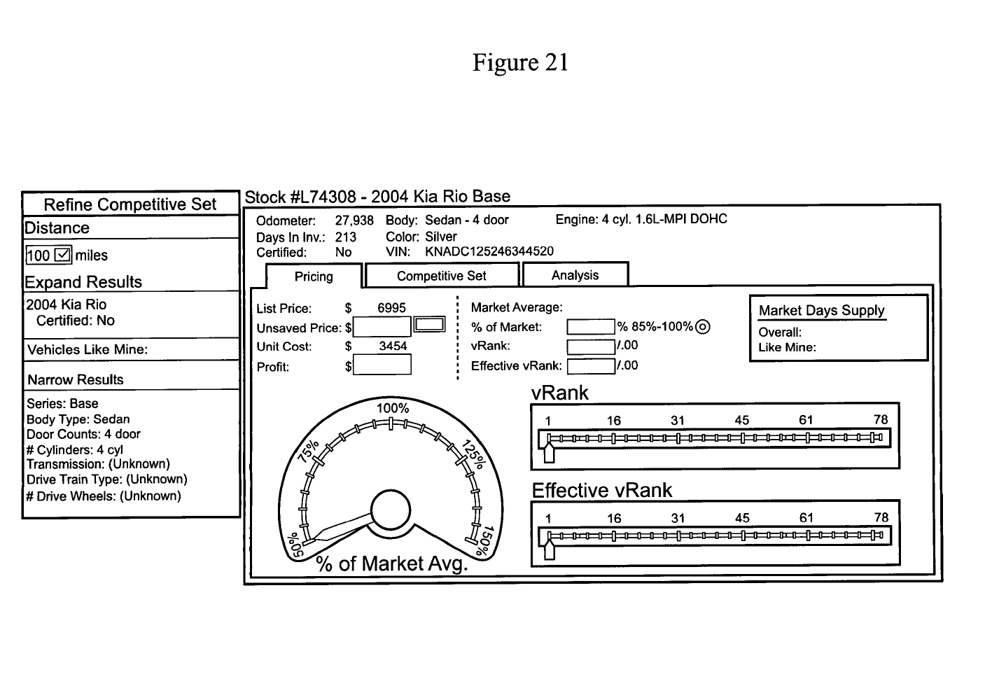

Further, FIG. 21 shows another embodiment of the present invention, the functionality called “vMax,” that automatically maximizes the asking price based on any selected “effective vRank” or “vRank”. The vMax functionality finds the highest possible price while maintaining a pre-selected market rank position, i.e., vRank 166 or effective vRank 168. A user can use the vMax functionality to determine the optimal price for a given vehicle, recognizing its current market position with respect to its competitors, and the strategic value of that position. The user has the ability to have the vMax functionality automatically set prices for its used inventory, thereby, serving as the foundation for developing, setting and implementing internal and/or an internet pricing strategies for at least one used vehicle in inventory.

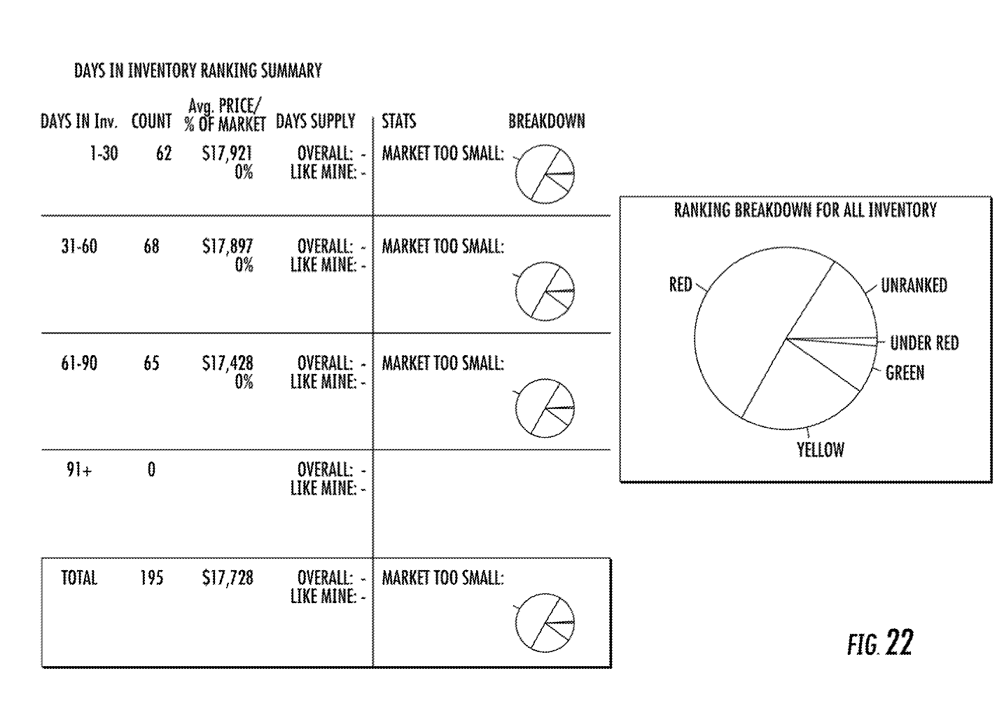

FIG. 22 shows a report for the “Days in Inventory Ranking Summary.” This report includes chart and pie formats to demonstrate the number of days that automobiles are in the inventory.

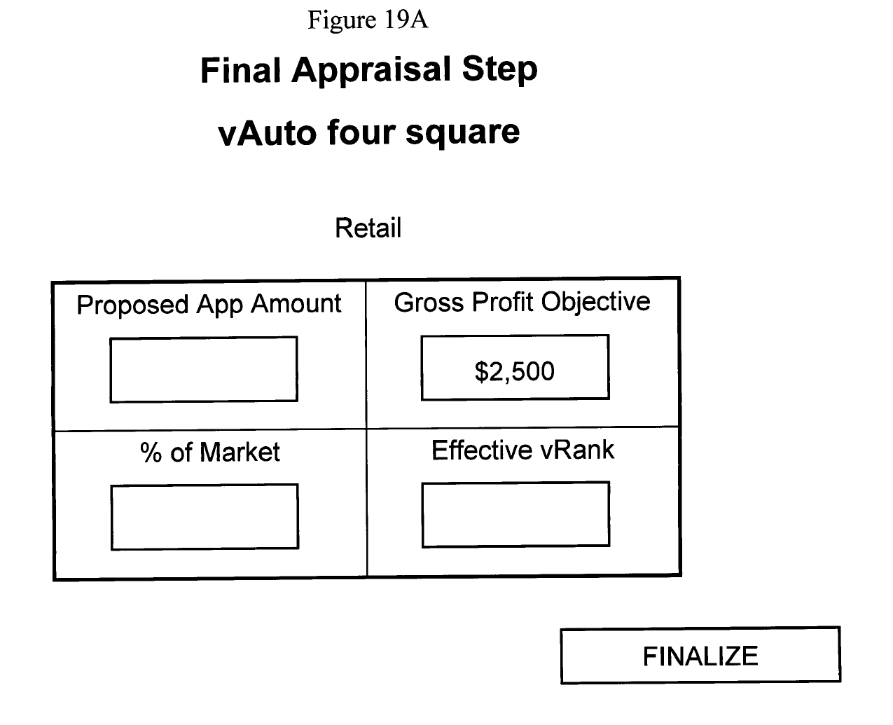

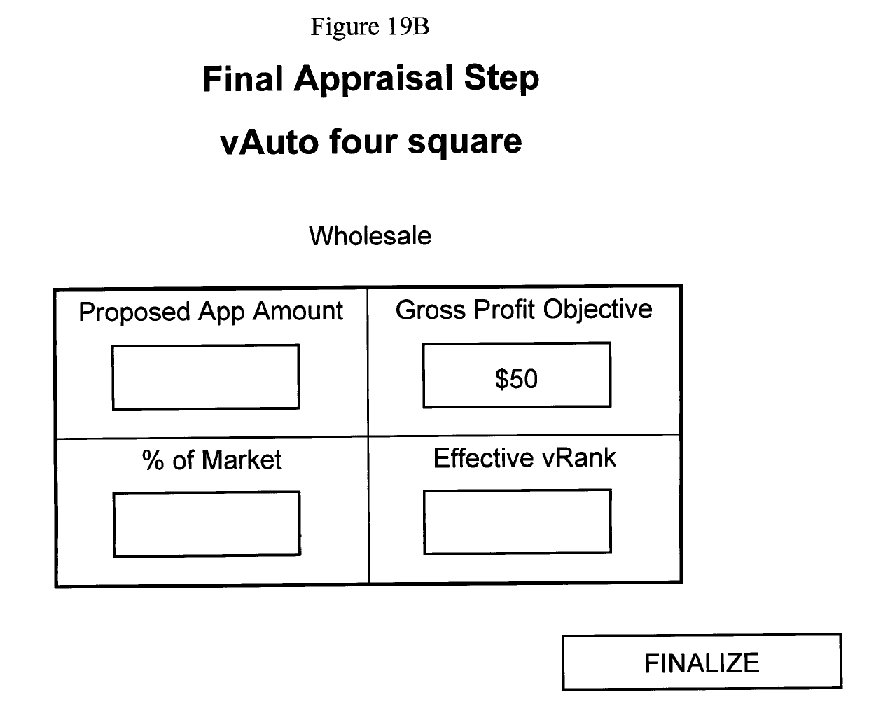

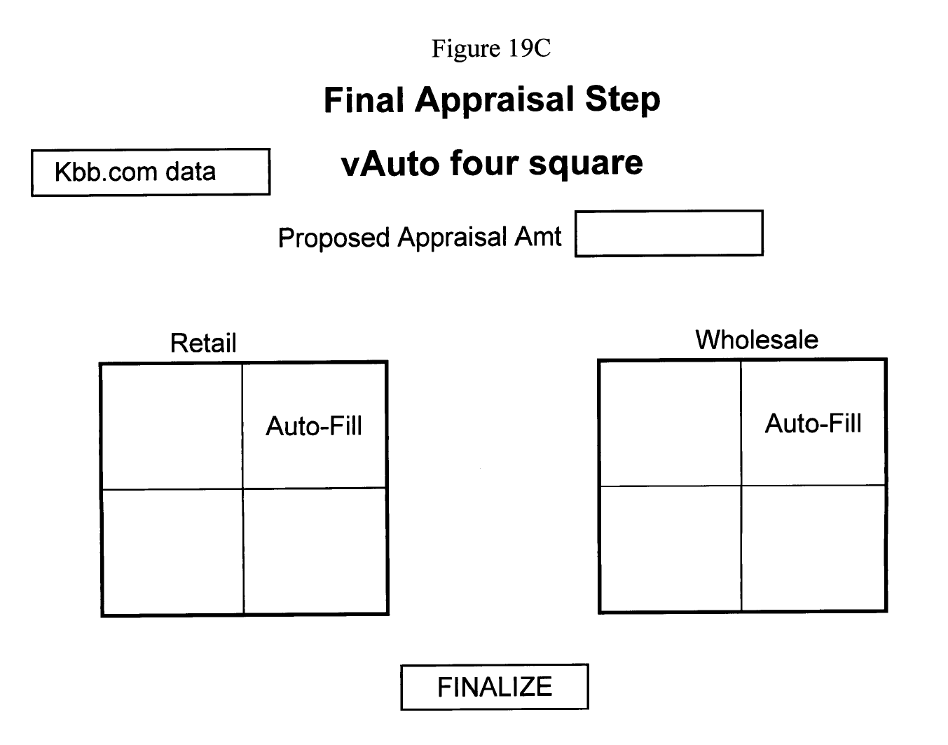

FIG. 19A-C shows another method for assessing the relationship between the proposed acquisition amount, the dealership's goals and the present retail market/wholesale market. This method, the VAuto Four Square, allows a user to insert and/or change variables and thereby dynamically recalculate the remaining variables (in this case, the remaining three variables).

Although numerous variables are contemplated for this method, some of the examples include the proposed appraisal amount, the target gross profit, the percentage of market and the effective vRank. The default profile includes those vehicle attributes that are pre-selected by the system for determining the competitive set as described above.

By changing some or all of these variables, the user is then presented with the dynamic results after recalculation. FIG. 19A shows a retail calculation for the VAuto Four Square method for variables including the proposed appraisal amount, the percentage of market, the effective VRank and the gross profit objective. For example, as the user changes the gross profit objective, the other variables will be recalculated. FIG. 19B shows the same variables, but for a wholesale transaction having a lower gross profit objective. FIG. 19C provides similar information, but displays the dynamic variables while also comparing the retail and wholesale markets.

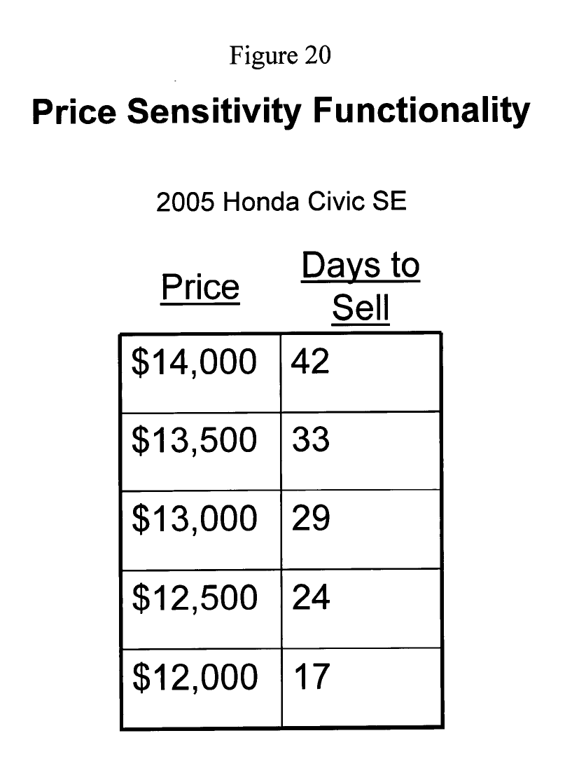

As shown in FIG. 20, for a uniquely configured vehicle, a user has the ability to input at least one price and dynamically obtain the number of “days to sell” for that vehicle at that given price.

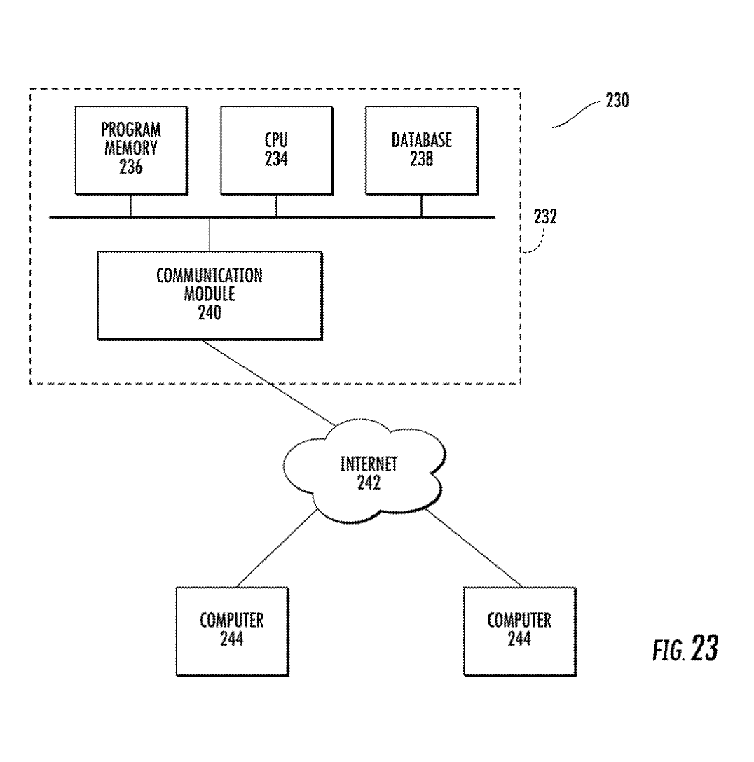

FIG. 23 is a schematic diagram of the present invention showing a system 230 in which a host computer 232 houses a CPU 234, a memory 236 and a database 238. The system also contains a communication module 240 which can access and communicate with a global communication network, such as the Internet 242. Other types of communication networks will also suffice, such as an Intranet, a Wi-Fi, Wimax, cellular or other networks.

In the program memory 236 is the application software to run the present invention and allow users, or dealers, to access the applications through the Internet 242 using their remote computers 244.

At the outset, the host computer 232 (or another computer), using harvesting technology, obtains information pertaining to various automobiles for sale. This information is parsed to obtain the descriptions of the automobiles, mapped, normalized to various descriptors, and stored in the database 238. The database may be located in the host computer 232, or may be on another computer or at a remote site. The information necessary to populate the database 238 is always changing and thus must be updated continuously.

Once data is harvested and normalized, the present invention allows for the creation of a new retail pricing guide book based on live market date, known as the rbook. The rbook is available through the appraisal tool as a source of additional data on current market pricing. It allows users to select specific trim and features which result in the elimination of similar vehicles that do not match the exact configuration of the vehicle under evaluation. The system therefore profiles the quantity, average retail price, and mileage of comparably equipped vehicles in the designated market area.

FIGS. 24 through 31 show the present invention integrated as one application to provide all the functionality described herein. Although integration is not necessary, there are numerous advantages to integrating the various applications.

As described herein, the system harvests information pertaining to automobiles for sale and parses out the description of those automobiles in order to normalize to a particular descriptor. For example, one automobile may describe a NAV system, while another may indicate a GPS device. The present invention normalizes these descriptions to a particular descriptor, i.e, a navigational system.

Once the information is harvested (on a continuing basis), the present invention can display this information along with the dealer's inventory information in a number of ways.

FIG. 24 shows the main page of the pricing tool 250. With this snapshot, the dealer can obtain numerous summaries of inventory. The inventory can be ranked by age group 252, ranking totals 254, and a summary of the days the vehicles have been in the inventory 256. The summary can also indicate total investment 258, average investment 260, among other information. Also, the dealer can receive information about automobiles that are slow moving or need attention 262, i.e., revised selling price, etc. Additional tabs allow the dealer to obtain more information about the inventory. The Investment Summary tab 264 and Appraisal Summary tab 266 take the dealer to additional screens for more detailed information.

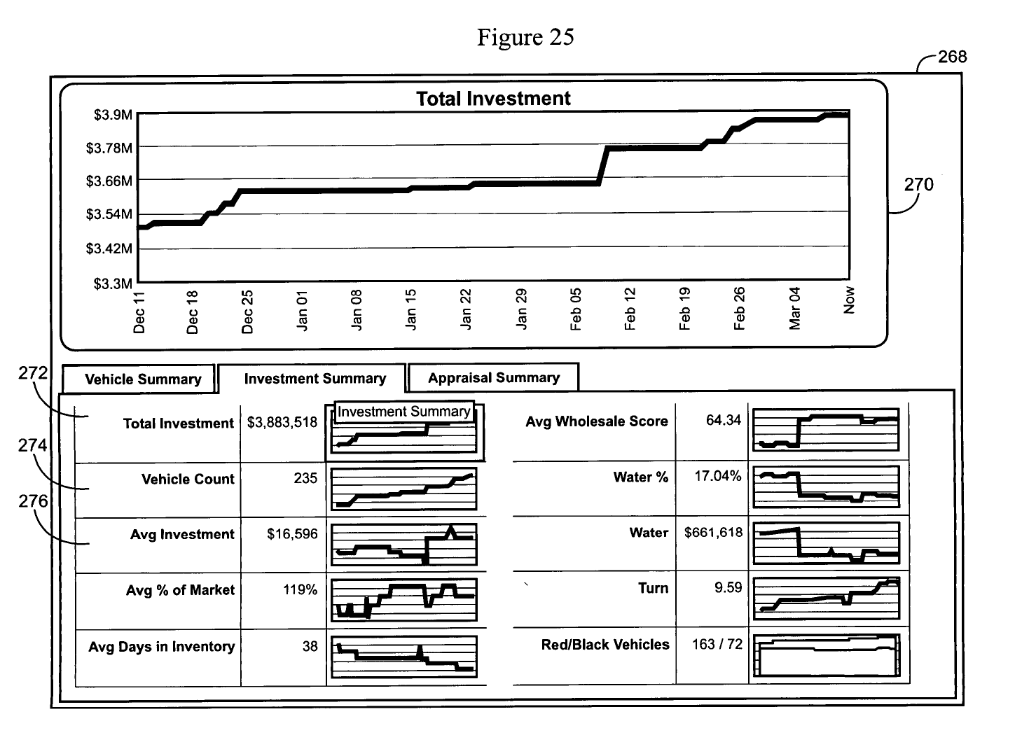

FIG. 25, the Investment Summary 268, is displayed when the Investment Summary tab 264 is selected. The Investment Summary 268 indicates the dealer's total investment 270, based on all vehicles in inventory (or a subsection of those vehicles, if not all are selected). Additional information is displayed in chart form; however, the information can be displayed in any manner. These charts include total investment 272, vehicles count 274, and average investment 276, among others. Any information pertaining to the dealer's inventory investment can be displayed here.

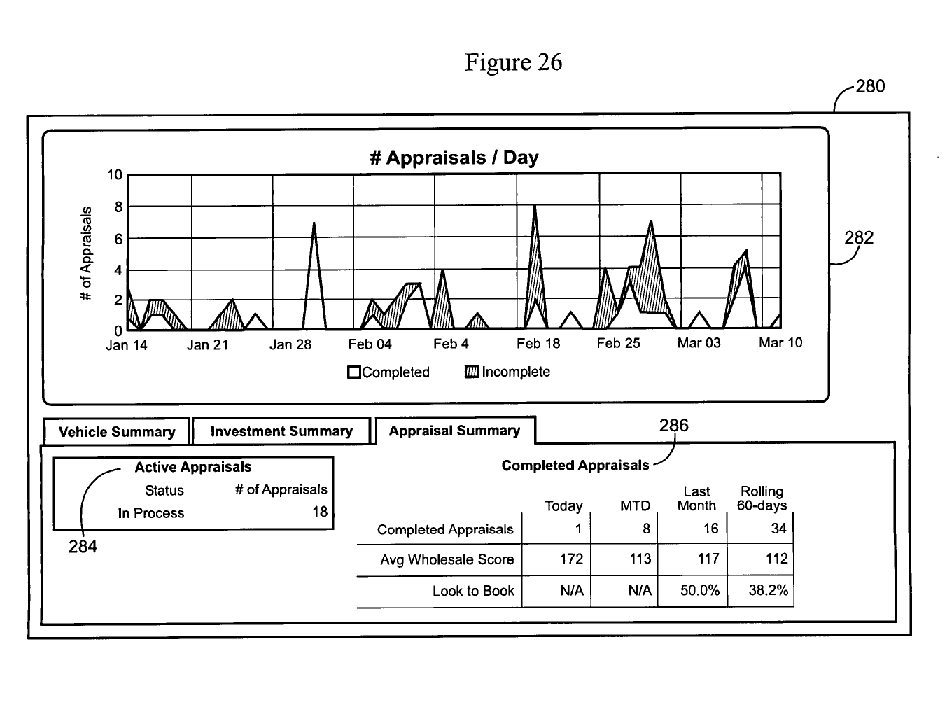

If the dealer selects the Appraisal Summary tab 266, the Appraisal Summary Screen 280 in FIG. 26 will be displayed. The Appraisal Summary Screen 280 indicates a chart of the number of appraisals per day 282, along with information pertaining to the active appraisals 284 and the completed appraisals 286. As shown in FIG. 26, the completed appraisals can be broken down further into categories.

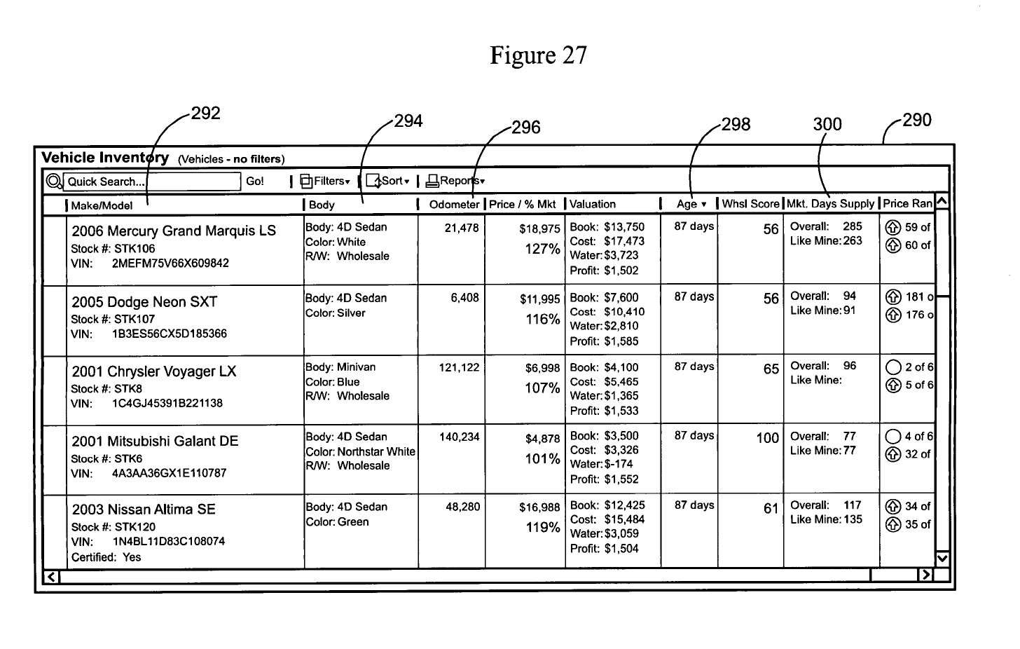

FIG. 27 shows a breakdown of the dealer's inventory 290 by each automobile. The screen displays the make, model and year 292 of each automobile along with body trim 294, mileage 296 and various other information pertaining to the inventory. The dealer can also quickly see how long each vehicle has been in inventory 298 and a comparison of days in inventory to various markets 300. The inventory screen also shows the price rank 302 for each automobile. Additional information about each automobile may be disclosed.

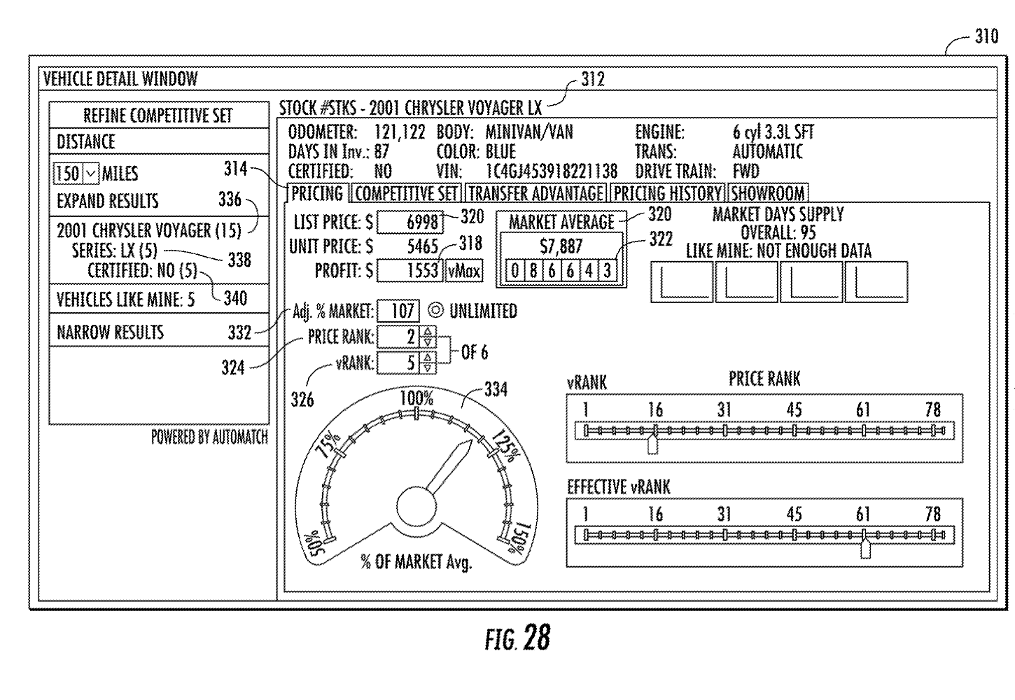

FIG. 28 shows a particular automobile's information on a Vehicle Detail Window 310. This window 310 provides the dealer with a dynamic tool for changing the selling price to optimize the sale.

The window 310 indicates the details pertaining to the particular automobile 312, in this case a 2001 Chrysler Voyager LX. Once the pricing tab 314 is selected, the display indicates the list price 316, profit at that price 318, market average 320, mileage 322, price rank 324 and vRank 326, among other information. The display also indicates the Price Rank and vRank slider bars 328, 330, in this case, from one to six. The adjusted percentage of Market is shown as a number 332 and as a dial indicator 334.

Also displayed for the user is information pertaining to the number of other 2001 Chrysler Voyagers in the sample 336, in this case 15, the number of LX's 338, five, and the number of vehicles certified 340, also five. Other information includes Market Days Supply and information about the vehicle. More or less information may be included.

As described herein, the present invention is both integrated across the different applications, and dynamic insofar as updating the system automatically upon revisions.

FIG. 28 also shows that much of the information pertaining to the focus vehicle, in this case, the 2001 Chrysler Voyager LX, can be modified in order to revise various outcomes, including Price Rank 324, 328, vRank 326, 330, profit 318, etc. Further, the Competitive Set can be narrowed or broadened and doing so will revise the outcome.

For example, if the dealer wants to move the vRank 326, 330 for this vehicle from 5 (currently) to 2, he can enter the number 2 into the box 326 or move the slider 330 from 5 to 2. The system will automatically revise the list price 316 (downward) to obtain a vRank 326, 330 of 2. In turn, the profit 318 will also be reduced and the adjusted percent of market 332 will change accordingly.

Also, the dealer can revise the Competitive Set to include non-LX Chrysler Voyagers, for example. Now, the Competitive Set will include 15 models 336, not 5 338. The Market Average 320 price the mileage 322 will be revised based on the new Competitive Set. Although there will now be 16 vehicles in the Price Rank 324, 328 and vRank 326, 330 (15 vehicles from the Competitive Set and the focus vehicle), the Price Rank 324, 328 and vRank 326, 330 will be revised dynamically. Most of this information can be revised dynamically to obtain new results.

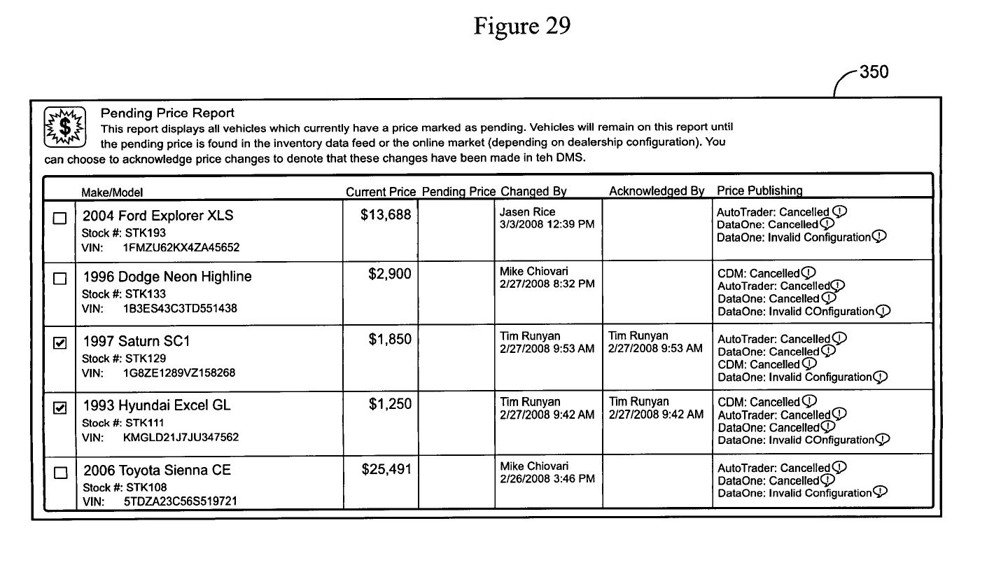

FIG. 29 shows a Pending Price Report 350, which displays all of the vehicles that have a price marked as pending. The dealer has the ability to acknowledge the price change or denote that the changes have been made.

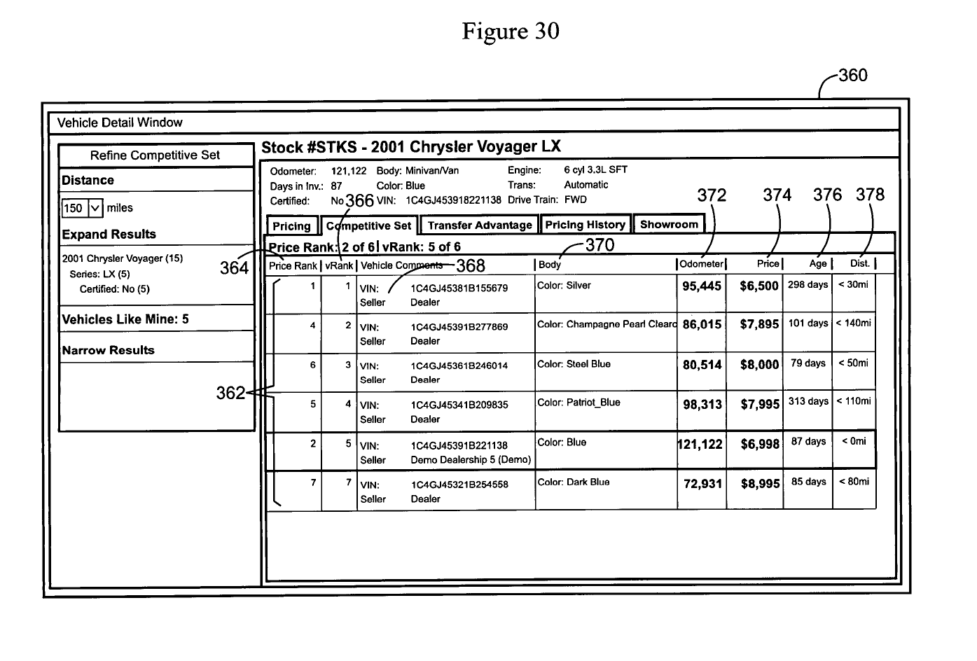

FIG. 30 displays the Competitive Set 360 for the same 2001 Chrysler Voyager LX. This screen is displayed when the Competitive Set radial button is selected from FIG. 28. FIG. 30 shows each of the 2001 Chrysler Voyager LX vehicles that were used to generate the focus vehicle's price rank and vRank. Each of the vehicles is displayed in a separate row 362, along with its Price Rank 364 and vRank 366. Also shown are the Vehicle Identification Number or VIN 368, information about the body 370, the mileage 372, price 374, Age or days for sale 376, and the distance the automobile is located from the dealer 378. Again, more or less information can be displayed here as needed.

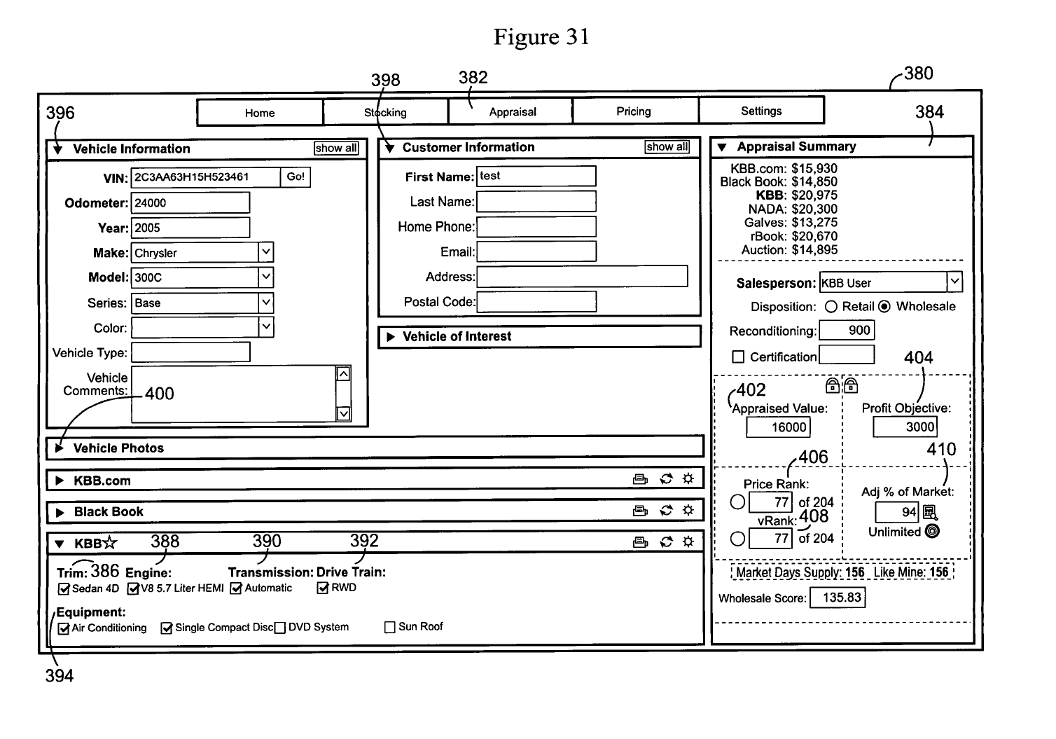

FIG. 31 shows the Appraisal Window 380, which is accessed by selecting the Appraisal radial button 382 throughout the program. Since the applications are integrated, the Appraisal window 380 can be accessed from multiple locations. Once in the Appraisal window 380, the dealer can enter or modify information 396 about the focus vehicle to find the optimal selling price for the focus vehicle. The Appraisal summary 384 indicates the pricing of the particular vehicle from a number of sources, as describe above. Further, the dealer can change the information about the particular vehicle, such as trim 386, engine 388, transmission 390, drive train 392, and equipment 394, among others.

The dealer can also enter customer information 398 as necessary. Also, the Appraisal screen 380 can allow the dealer to see Vehicle Photos 400.

As described above, the Four Square functionality allows the dealer to dynamically change one of the following: Appraised Value 402, Profit Objective 404, Price Rank 406, vRank 408 or Adjusted Percentage of Market 410, by revising the other values. For example, by revising the Appraised Value 402 downward, the Profit objective 404 will reduce, however, the Price Rank 406 and vRank 408 will improve. These values and others can be used in this Four Square functionality to obtain the optimal price.

Since this system is integrated, making changes in the Appraisal Window 380 will modify the values in other windows when later viewed.

### Stocking Tool

The present invention also includes a stocking tool. The vAuto stocking tool compares a dealership's used vehicle inventory stocking profile to that of sales in the dealer's market. The system does this by identifying supply and demand for each vehicle at a year, make, model, and trim level. This system quantifies the number of each uniquely configured vehicle (available) and compares it to the current available supply. A user can query the market using the stocking objective slider bar to identify vehicles that are selling in the highest volume, lowest day supply, or balanced by both criteria.

This system also compares dealer's current inventory to market sales data by vehicle segment according to price class. Once a dealer determines the vehicles that need to be purchased for inventory, they can be automatically transferred to the buy list. In the process, the dealer is asked to specify a desired day's supply quantity. The system will consider dealer's present stock and past sales to derive a quantity to be purchased to meet the stated stocking objective. The dealer can view currently available vehicles for sale that match those which need to be purchased and automatically submit a wholesale purchase request to the selling dealer or private party.

Independent of the dealer's inventory, the dealer can also query the database using the stocking objective bar in the manner described above to identify the fastest moving, lowest days supply or balance of both with certain criteria such as year, make, price class or dollar value. The stocking tool calculates and then generates a variety of lists of top selling vehicles dependent upon sorting criteria. These lists can be generated and sorted based on a number of variables, including but not limited to market days supply, available vehicles, and sales rates data over any specified number of days. The lists are created at various levels of detail, including vehicle type and class, year, make, model, and trim specification.

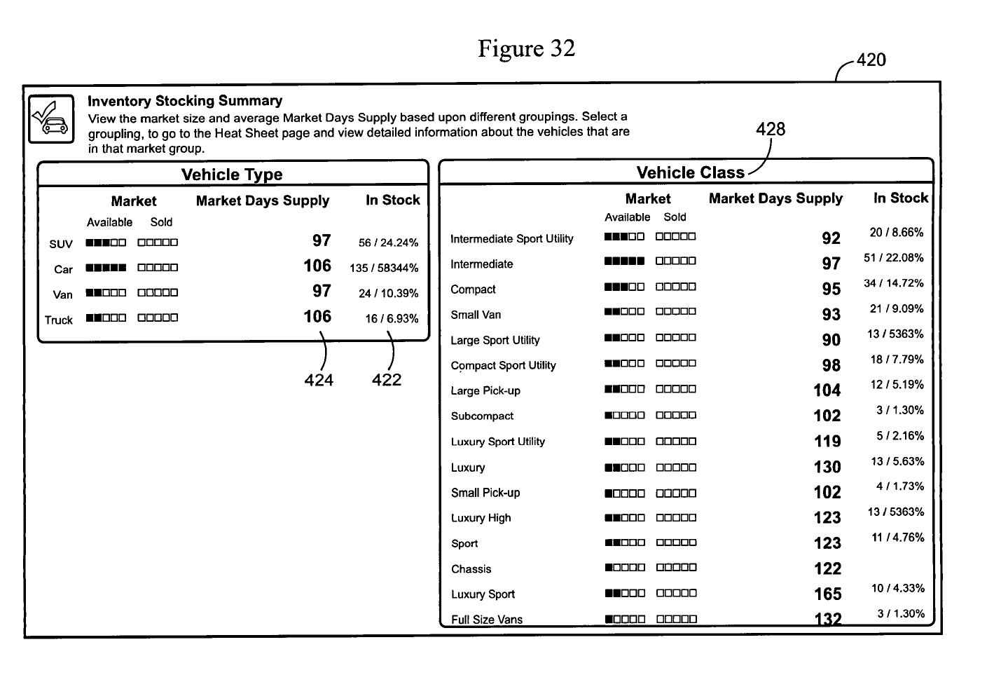

FIGS. 32 through 36 show the stocking tool results as displayed on the screen.

FIG. 32 is an Inventory Stocking Summary window 420. The window 420 shows the market size 422 and average market days supply 424, for Vehicle Type 426 and Vehicle Class 428.

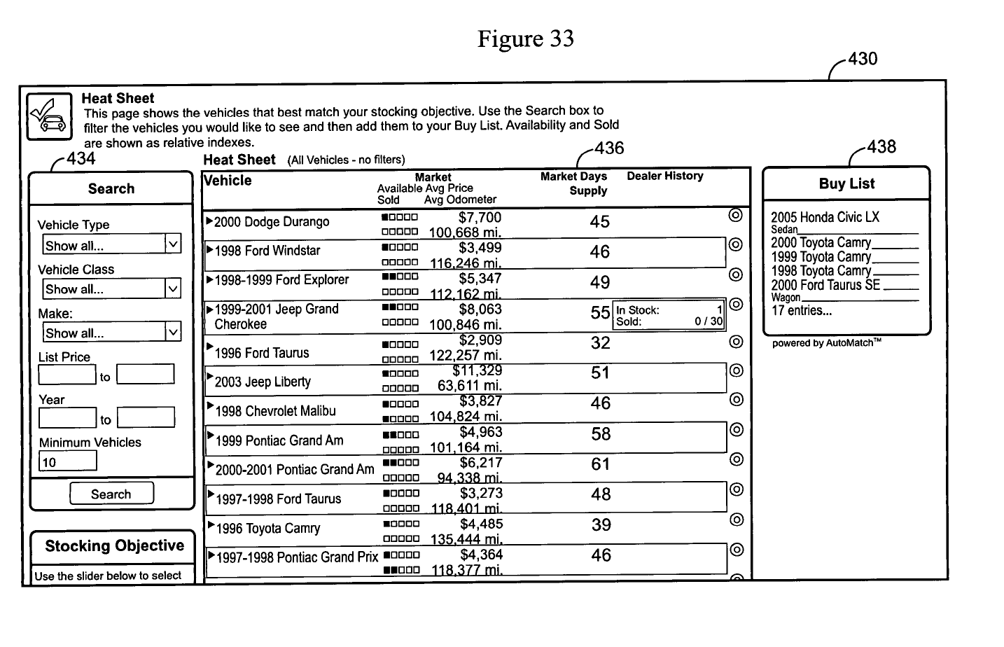

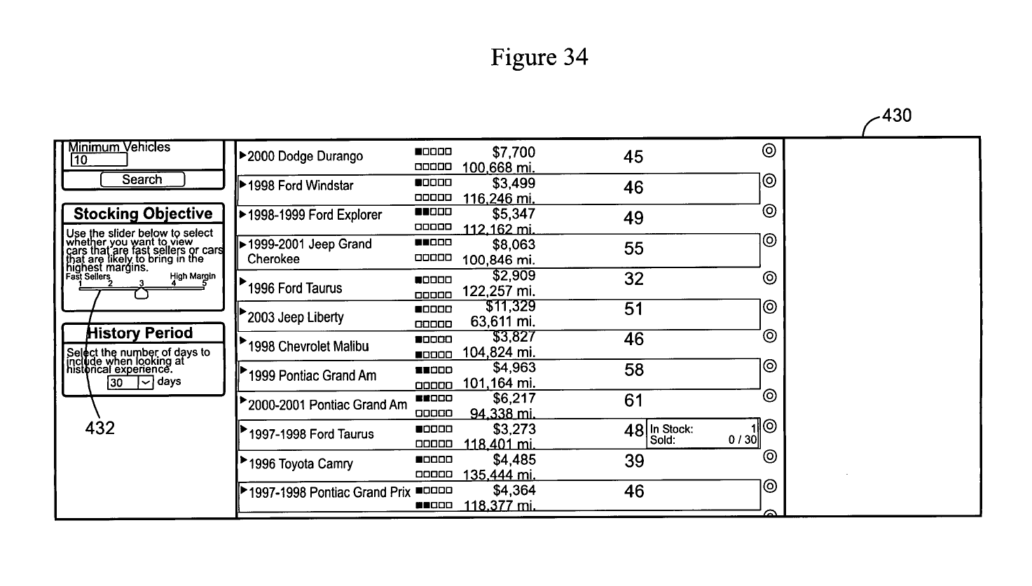

FIGS. 33 and 34 show the Heat Sheet window 430 (FIG. 34 is the same as FIG. 33 but scrolled down to indicate the slider bar). The Heat Sheet window 430 shows the vehicles that best match the dealer's stocking objectives. The dealer can enter various search terms 434 for a particular Vehicle type and class.

The present invention includes “slider bar functionality” 432 as a way of selecting and defining those vehicles to be displayed on each list based on a “slider” 432 which balances multiple metrics including but not limited to market days supply 436 and sales rate data. Additional sorting criterion can also be incorporated. One outcome from sorting used vehicles as currently configured is the ability to pinpoint high demand, high volume, fast turn vehicles as well as high demand, low volume, high margin vehicles. The resulting data are displayed in FIGS. 33 and 34.

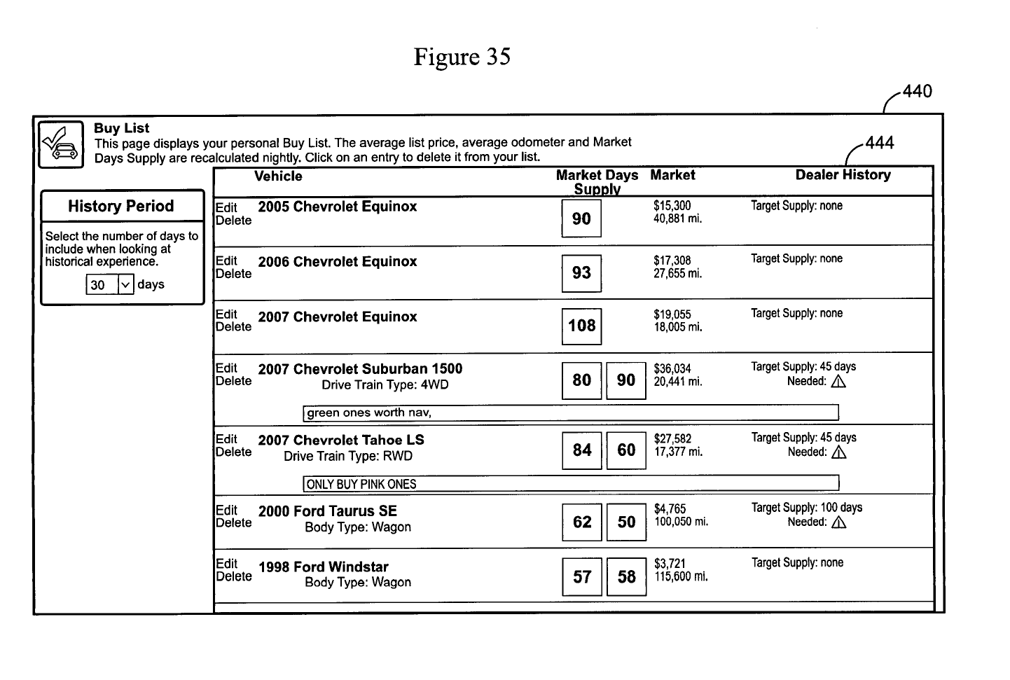

The stocking tool also includes the functionality for a dealer to identify and select which vehicles he might like to stock, thereby creating a unique and distinct buy list 438 for every dealer in his or her market. FIG. 35 shows the Buy List window 440, which includes vehicle detail at the year, make, model level 442 as well as but not limited to vehicle specifications down to a trim level. Dealer history data 444 is incorporated into the Buy List 438, allowing dealers to view their prior results and then set target stocking levels based on their past experience.

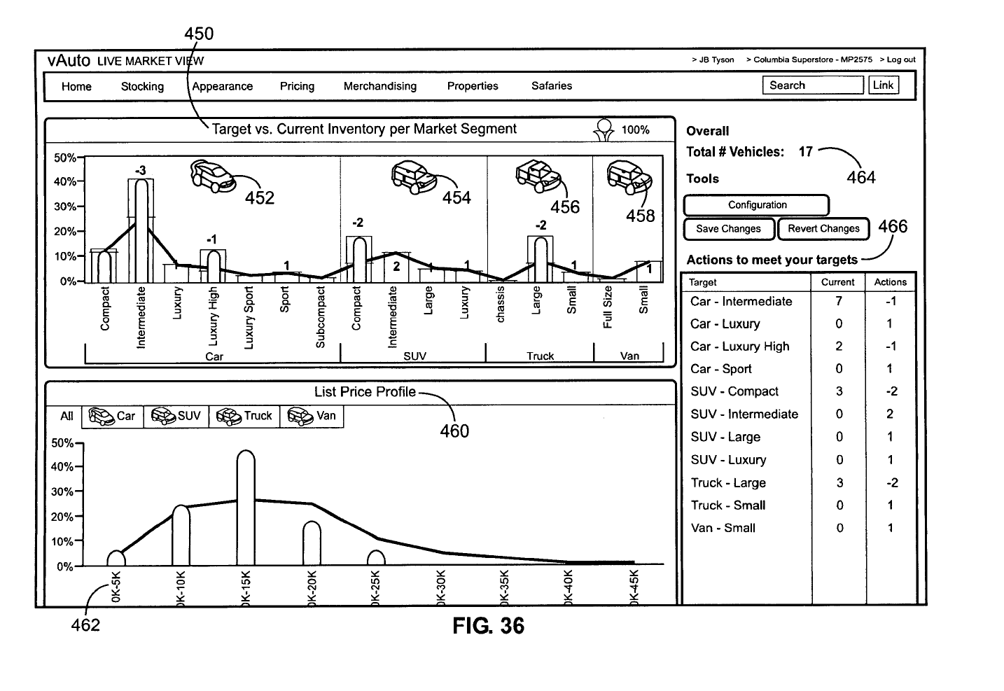

FIG. 36 shows the Stocking Tool results (also known as the Live Market View) in a graphical format dividing up the dealer's inventory by Target vs. Current Inventory per Market Segment 450, by car 452, SUV 454, truck 456, and van 458. Of course any division of the inventory is possible. The chart also indicates the List Price Profile 460, in this case dividing up the segments by $5000 increments 462. The also indicates the total number of vehicles 464 and how many actions are necessary to meet the targets for the particular segments of automobiles 466.

### Real Deal

### Inventory Management and Selling System.

The present invention utilizes customer report functionality, described herein as the Real Deal functionality and reports, which address some of the realities that exist within a dealership. First, most dealerships are not prepared to offer a single price for a vehicle. This one price approach is presently used by only a small percentage of dealers and it is therefore necessary that dealerships have the ability to use Real Deal in a manner that is consistent with whatever selling philosophy they have. Second, the number one priority of sales management each day is to sell vehicles. This focuses their attention on two primary areas: daily walk-ins/virtual inquiries and follow-up on prior shoppers.

With respect to present walk-in shoppers, dealerships accept the need to have a disciplined approach. The most common and best known is referred to as the “10 steps to the sale.” The 10 steps include meet/greet, qualify, lot walk, walk around, test ride etc. Not withstanding the recognition of the need for process, there is very little “best practice” for presenting the price of a vehicle.

With respect to virtual, i.e., internet/telephone shoppers, there is much debate as to best practice. For example, many believe that a price should never be quoted to a customer that isn't present and others believe that it is unfriendly and unwise not to do so.

When it comes to prior shoppers, there is universal recognition for the need to follow up. This is where CRM solutions provide value. There are, however, serious short comings in traditional CRM solutions. First, they depend on highly accurate notes surrounding the shopper's experience. This is often a problem due to sales personnel's lack of attention to detail. The second problem with traditional CRM is that it lacks the ability to monitor and report on shopper's interest and behavior once they have left the dealership. Managers attempting to follow up on prior day's opportunities often have to work with scant notes about the experience and inferences about the consumer's interest.

In any case, whether a customer is present, virtual, or a follow-up, dealerships perceive the need for process and are searching for a solution for presenting a value price and more effectively following up on previous sales opportunities. The need to have a consistent, intelligent solution for presenting price and following up (present or virtual) in a manner consistent with the dealership's philosophy is addressed by Real Deal as described below.

In order to understand how Real Deal works, consider the following scenario. A shopper and sales person engage on the lot and settle on a vehicle. The sales person seats the prospect and says that they will get a price on the vehicle and be right back. The sales person confers with the manager to determine the best price to offer that customer in light of the prevailing circumstances.

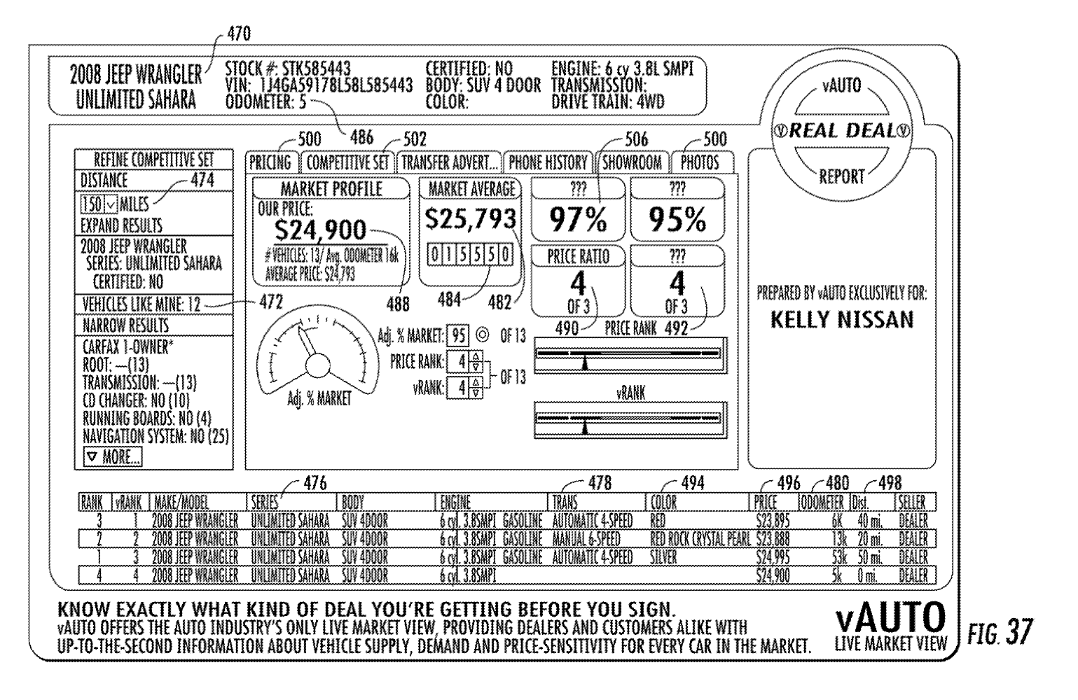

Once agreed upon, the manager or the sales person logs into the present invention, the Real Deal website, pulls up the vehicle in inventory, and clicks a link on the gage page called Real Deal. The manager or sales person enters the opening price into the Real Deal screen and selects the sales person's identification number. The resulting page on the screen, which can be shown to the customer or printed out, is similar to the display shown on FIG. 37, but populated with the resulting information. The sales person then returns to the customer and the following exchange occurs:

Sales Person: Now that you have selected a vehicle, the 2008 Jeep Wrangler 470, I am going to explain how our dealership determines its price. As you probably know, our reputation is to provide great vehicles at great value prices. The way we do this is to use the service of a company called Real Deal.com. You can learn more about Real Deal.com by going to its website www.realdealreports.com.

Take a look at the Real Deal website that I have just pulled up. I am going to type in the stock number of the vehicle that you selected and take a look at what it tells us. First, you can see that there are a total of 13 '08 Jeep Wranglers 472 in a 100 mile radius 474 of our dealership. Moving down the left rail of our screen, you can see that all of them are Unlimited Saharas 476, and eight of them have automatic transmission 478, and of those eight only two others have less than 10,000 miles on them 480. You can see that the average asking price is $25,793 482 and the average mileage on these cars is 15,550 484. Our vehicle's mileage is 5,000 miles 486 and our asking price is $24,900 488. Based on a ranking system of price, this means that our price is the 4th best deal in the market 490. If you consider mileage and price together, we are the 4^{th} best value 492.

Another way to look at it is that without any hassle of back and forth negotiation, we are offering you a price that is 97% of market 506, in other words, right in the middle of the competitive pack. (Note: the Real Deal price presented to each customer may be different. This is important because most dealerships are not prepared to have a single price to all customers. The “desk” or sales manager can determine customer by customer what price they want to use to “open the customer.”)

Let's take a look at the competitive set and specifically the 1 vehicle that is ranked slightly higher in terms of value (note: can drill down to see photos of each vehicle but not the selling dealership's name). Now it is true that the other vehicle is a color 494 that you would consider (red) and appear to be real contenders, but the difference in price 496 is only $1,005 between #1 and ours and that dealer is located 40 miles away 498. I am sure that you would agree that our approach of being straight up and no hassle along with our great reputation for superior service after the sale justifies our price. (Or alternatively, let's close the deal now and I will match the best price—let me plug in $xxx.)

Other information about the automobile that can be used to limit the competitive set may include certification by Carfax, meaning that these vehicles do not have multiple prior owners and/or possibly salvage/flood titles or may even have had major accident repair. The vehicle color may be important to the customer, thus by clicking on/eliminating these types of vehicles (they become shaded in gray), the value rank 492 can be revised accordingly.

Customer: Wow, that's pretty impressive information about the market, but I still want to think about it and possibly do a comparison of my own.

Sales Person: No problem at all, would you like to have the ability to access the information that I just showed you on your own? In fact, every time you check in on this vehicle at realdealreports.com you might find this vehicle's value slightly different as it monitors the market and it will show you when new competitors arrive and others are sold. It will also show you if we lower the price on this vehicle or sell it. You will see this same menu bar when you log in. You will see the competitive analysis 500 (what I just showed you), the competitive set 502 (we just looked at that too), a Carfax or AutoCheck report (if available), photos 504 of our vehicle, and a description about our car, and another tab describing our warranty and dealership service and personnel. Just like we did here, you'll be able to expand or contract the market radius, “grey out” competitive vehicles, and even model price rank, vRank, percent of market against price.

Customer: That sounds great. How do I access the information?

Sales Person: It is very easy. We can enter your name and contact information right now and it will text you a username and password or you can simply text the code 4040 from your mobile phone and it will send you the same information by a text message. When you login you will be able to see the most current information about this vehicle as well as the opportunity to email or text me a message like a question or an interest in a purchase. It will also provide a message that tells you how many other shoppers are tracking this vehicle as you are and a text notification that will notify you if a condition has occurred such as a change in rank 490, 492, percentage of market 506, price 488, and/or vehicle's availability status (i.e., sold, however, the notification will only convey a message that one of the aforementioned statuses has changed, but not the actual change itself as incentive for the shopper to login or contact the dealership).

Once the shopper leaves the dealership, the Real Deal system will track every shopper's login and will associate it with each respect inventory unit and their Real Deal Report. Moreover, the system will display for management the identity and frequency of shoppers checking in on a vehicle. The quantity and frequency of check-ins will indicate the shopper's interest level and possible position in the shopping process.

For example, the shopper that logs in 2-3 times per day after leaving the dealership is likely very close to making a purchase decision in favor of the dealership's vehicle. A shopper that does not log in at all is likely not very interested. These patterns of logins or lack thereof can assist the dealership in tailoring the most appropriate type and method of follow up.

When a customer logs in, they will have limited ability to modify the information. They should be able to expand or contract the market radius as well as “grey” or “ungrey” vehicles in the competitive set. The present invention provides the customer with the sense of transparency and usefulness. If it is a valuable experience for the customer it is highly likely that they will ask other dealers whose vehicles are also under consideration for the same functionality.

The shopper will have the ability to fill out a request for the Real Deal functionality, and that request would be sent to other non-participating dealerships whose vehicles are also under consideration. The request would contain a message as follows: “John Doe, a present shopper at your dealership, has requested that you provide him with the functionality and transparency of the market through realdealreports.com. By clicking on the following link you can learn more about this system and how to sign up your dealership.

Alternatively, many shoppers may not visit the dealership's showroom at all but, rather, communicate electronically. If a shopper identifies a vehicle of interest, they can submit a request for the Real Deal price along with their name and mobile phone number. This would be accomplished by clicking on a Real Deal link from the dealer's website and/or potentially third-party sites. The system will generate and text a user name and password to the virtual shopper. This method will ensure that the dealership obtains necessary contact information for each inquirer. This request will either trigger an automatic response with a Real Deal equating to the advertised price, a pre-determined discounted Real Deal price or notification to a an appropriate manager to establish a Real Deal price for that particular customer.

Once a Real Deal link is sent to the virtual shopper along with a user identification and password, the shopper would see a presentation of the report similar to that described above when offered by a live sales person. This presentation, however, would take the form of a virtual tour of the report explaining each information component and the system's functionality.

This price delivery functionality for the dealer, when used along with the virtual transparency for the customer, acts to align the sales process with the entire car-buying experience, and in particular, the Internet car-buying experience. This is not necessarily a CRM solution. While it may contain some customer information and/or follow-up notes, it is designed so as to integrate with existing CRM solutions. It is reasonable to think of Real Deal as a price/quotation system. Such a system does not presently exist in any form in the retail automotive industry. It is superior and more effective to the goal of making a sale “right now.” This is because it contains information that is most relevant to the transaction (price) and reports levels of interest on the part of the shopper outside the dealership environment. These are two critical aspects that are often not captured in CRM solutions and/or are beyond their technical ability.

As an example of the strength of the present invention, a manager comes into work in the morning and scrolls through his vAuto inventory. Each inventory record possessing a Real Deal report would show a status such as “Real Deal” (3). This means that there have been 3 price quotes on this vehicle. By simply clicking on the number the manager can see the shopper's name, contact information, sales person, price quoted, as well as the number and frequency of the shopper's log-ins. This report can be sorted so as to easily identify the hottest prospect for the vehicle and/or the highest profit potential sale.

Since there are different levels of priority for selling certain used vehicles based on age, model, and other risk variables, it is extremely valuable to link potential sales opportunities to each vehicle. This stands in stark contrast to traditional CRM solutions that start with the customer, not the car. For example, a sales manager on Monday morning might review all of the unsold prospects from the prior week but has no way of determining which prospects are the most important ones to the dealership. In contrast, the inventory manager and/or sales manager attempting to manage the dealership's inventory investment will likely focus on and pay attention to those prospects attached to vehicles that are most at risk from an age, equity, or profit perspective can use the Real Deal system. This is a subtle but very important advantage that will make the Real Deal system a preferred tool for both inventory and sales managers.

Another module of real deal would be an analogous system to produce a consultative and transparent trade appraisal.

### Step 1—Defining the Market and Defining the Vehicle

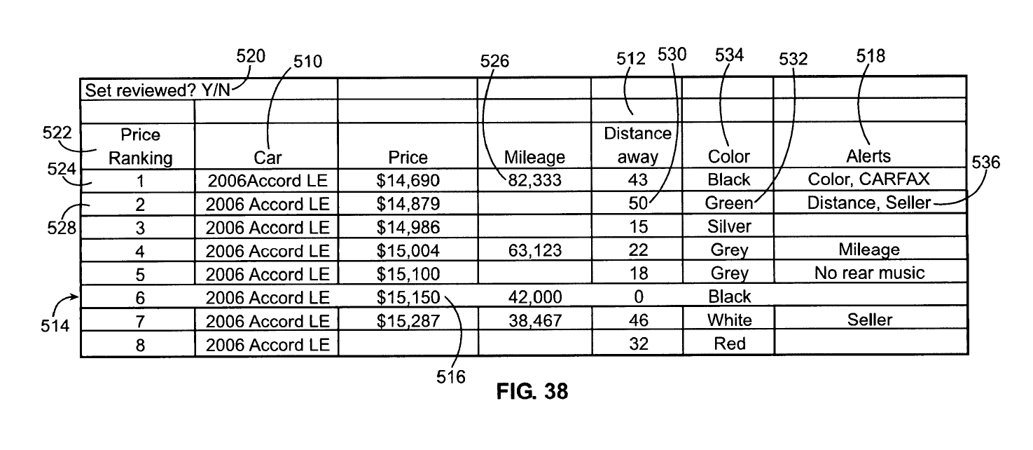

Voice: Let's take a look at how xxx dealership has arrived at the price for this vehicle. Using Real Deal Technology (as shown in FIG. 38), we can see that there are seven 2006 Honda Accords LEs 510 in a 50 mile radius 512, besides your automobile 514. By adding additional options, such as automatic transmission, moon roof, and navigation system, the number of identically equipped competing vehicles in the market will be reduced accordingly.

You can see here that the average asking price of the 6 vehicles whose price is known is $14,991 (not shown) with average miles of those with information is 61.308 (not shown). Since this dealership is committed to offering you a price that is a great value without any hassle, it is being offered to you for $15,150 516 plus applicable tax, title and fees.

### Step 2—Incorporating the Real Deal Technology

Every car in the resulting competitive set is simply displayed. Auto-Alerts 518 are pre-populated by the application using a combination of what's known (CARFAX data, etc.) and dealer preferences for Alerts 518 (all green cars, all distance>30, delta mileage>10,000 miles, etc.) Additional Alerts 518 (ex. seller not franchise dealer) are manually added. Once a competitive set has been manually reviewed, the “review box” 520 is marked. The application will provide a “needs attention” box to indicate that new cars have been added to any competitive set that has already been reviewed.

Voice: As you can see in the chart (shown in FIG. 38), this represents the sixth best price ranking 522 in the market. Let's take a closer look at those vehicles that hold a better price ranking 522. Notice the first vehicle 524 has an odometer reading 526 that is over 40,000 miles higher than this one. Also take note of the fact that this vehicle, according to Carfax, has a salvage title (not shown). I think that this one is not a true competitor, as an example, an arrow may be pointing and guiding through this demonstration. You can see that the 2^{nd} vehicle 528 is more than 35 miles 530 away, is green 532 in color 534, and is being offered for sale by a non-franchise dealer 536 that will not be able to provide same level of service as we can. The next vehicle, according to Carfax (not shown) has had multiple owners. Given these considerations, you can now see why the price of $15,150 516 is a great value and a certified real deal.

Accordingly, the default settings to build the competitive set could be more detailed than those shown, but exclude the “more button” features, leaving some room to use “more button” attributes in the “Alert” column 518. The competitive set could exclude “gavel” cars (not shown). The application could allow the dealer to model their Real Deal View to move vehicles to their “highest defendable price point”. This may result in suggesting a price increase or a price decrease. A dealer could chose to use the Real Deal View at different levels of proficiency/monitoring, such as, no regular or formal review processes, real-time review on the showroom floor/at the time of inquiry, 100% reviewed and modeled Real Deal View for every car in inventory.

The cars could be value ranked or price ranked—as leaving the mileage out of the ranking may help in providing additional “Alerts.” A preliminary list of Alerts 518 includes, but would not be limited to, CARFAX, distance from dealership, mileage, color, missing a left-hand rail attribute, and a non-franchise seller.

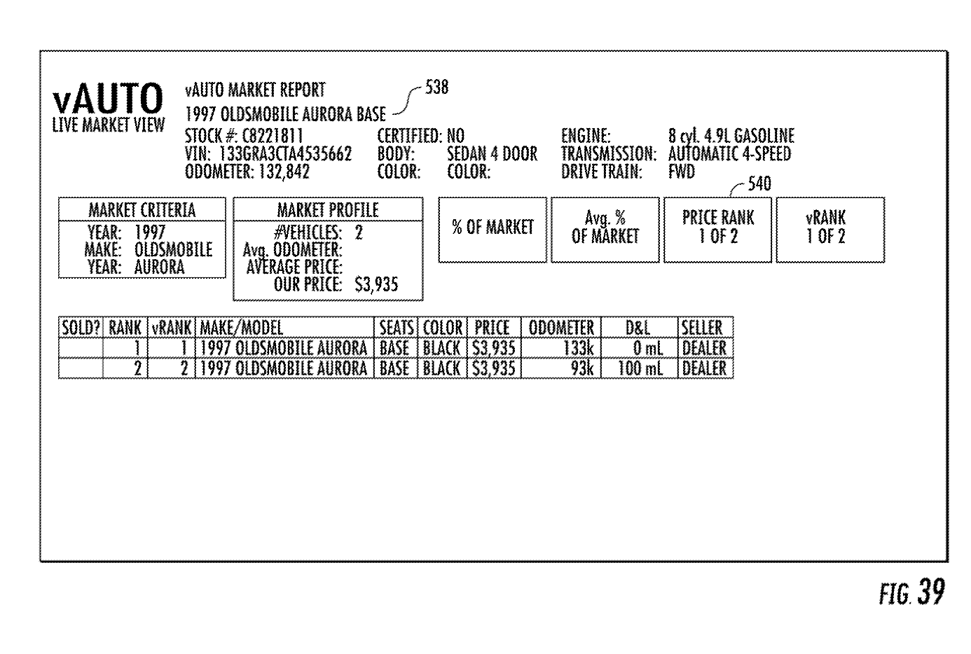

There are numerous ways to display the information for the dealer and for the customer, whether at the showroom or at the home computer or on the cellular telephone. FIG. 39 shows another type of display for the Real Deal Report, this time for a 1997 Oldsmobile Aurora 538, which has a price rank of first out of the two automobiles in the competitive set 540.

### Customer Tracking Process

After a Real Deal Report has been presented, whether in person or over the Internet, the customer would receive a customized “Real Deal” home page that would contain, at least a welcome message; SMS capability for dealership to communicate/send customized messages as well as to receive questions/inquires from potential customer with a message log capability (such as, “Hi Jill: We have received a lot of calls on this car this week. I hope we can make a deal. Give us a call”); date/time usage log; relevant updates, including, but not limited to, notice of price modification to target vehicle, notice of vehicles have recently entered/left the competitive set, interactive view of new/sold vehicles, notice of pending sale of target vehicle, notice of final sale of target vehicle, SRP results on AutoTrader/cars.com to indicate activity; a default expiration date, which create a sense of urgency, allows for extensions to be requested, the default can be adjusted; and a separate dealership information tab with links to dealer's inventory, dealership information and history with ability to request a different/additional Real Deal report tabs.

Further, every effort should be made to set up the home page with the customer before they leave the dealership, since each time the customer signs in to his page, a message as well as a date and time log will be transmitted to the dealership. The application would maintain an extensive lead tracking data base containing some or all of the following information:
a. Aid in understanding customer's interest level to gauge follow-up efforts
b. Provide supplemental metrics on activity level by vehicle

Also, the application would notify the dealer if, based on vRank, a relevant vehicle has entered the competitive set or a relevant vehicle has dropped off the competitive set. The purpose of these notifications is to allow the dealer to take appropriate action to modify prices on outstanding Real Deal reports.

It is possible that multiple Real Deal Reports may be outstanding for a single vehicle, the difference being the advertised price. Therefore, the application would need to associate each Real Deal report with its appropriate customer and track interest metrics by report. Accordingly, a single Home Page will be able to support multiple Real Deal Reports (might resemble tabbed browsing with distinct expiration dates for each tab). The dealership information tab would be purposely separate from the Real Deal data to maintain the integrity/neutrality of the Real Deal process

### Virtual Presentation

When a dealership provides a virtual Real Deal Report, the report would not “talk” about each car but, instead would utilize a Wizard to review the target vehicle as well as vehicles in the competitive set upon request. The Wizard may be a cartoon, specifically an inspector/detective styled bloodhound vDog/True Blue, which would guide the user through the report. Some of the characteristics of the wizard may include an inspector's cap, loyalty/tracker imagery, growl at alerts, sniffs its way through the competitive set (limited noises), and bark with excitement to announce a price change.

Because a Real Deal report will be used for a range of negotiation/pricing strategies, the virtual report would include the appropriate negotiation message consistent with how the Real Deal report has been configured. For example, if you're interested, let us know because the dealership will negotiate (or there is some negotiation room, or the deal is negotiable, or the deal is firm.

### Real Deal Appraisal Process

Similar to the Real Deal pricing process, there will be “Real Deal” transparency to work with a customer through the trade-in process. First, it must be determined whether or not the vehicle being appraised would most likely be considered for wholesale or retail disposition. Because there isn't any “advanced notice” that the car is going to be appraised, unlike a Real Deal Sale Report, a Real Deal Appraisal report doesn't exist until moment the customer enters the showroom.

To this extent, the application will provide a slimmed down version of the current appraisal application, without any 3^{rd} party guides, without all of the links and reports. Instead, split into 2 workstations:

Retail: The application should provide a simplified 4-square appraisal page, listing only rBook values and data. The rBook data would zoom in on the MDS, the number of similar vehicles, and then display the price/mileage of the top 3 cars in the competitive set.

### Retail Workstation

4-square (defaults set on recon+certification and profit)
rBook display showing the top 3 cars in the competitive set
Clear look at number of similar cars in a given radius and market days supply of the vehicle

### Wholesale Workstation

displays the Auction data.

### Virtual View or Merchandising Module

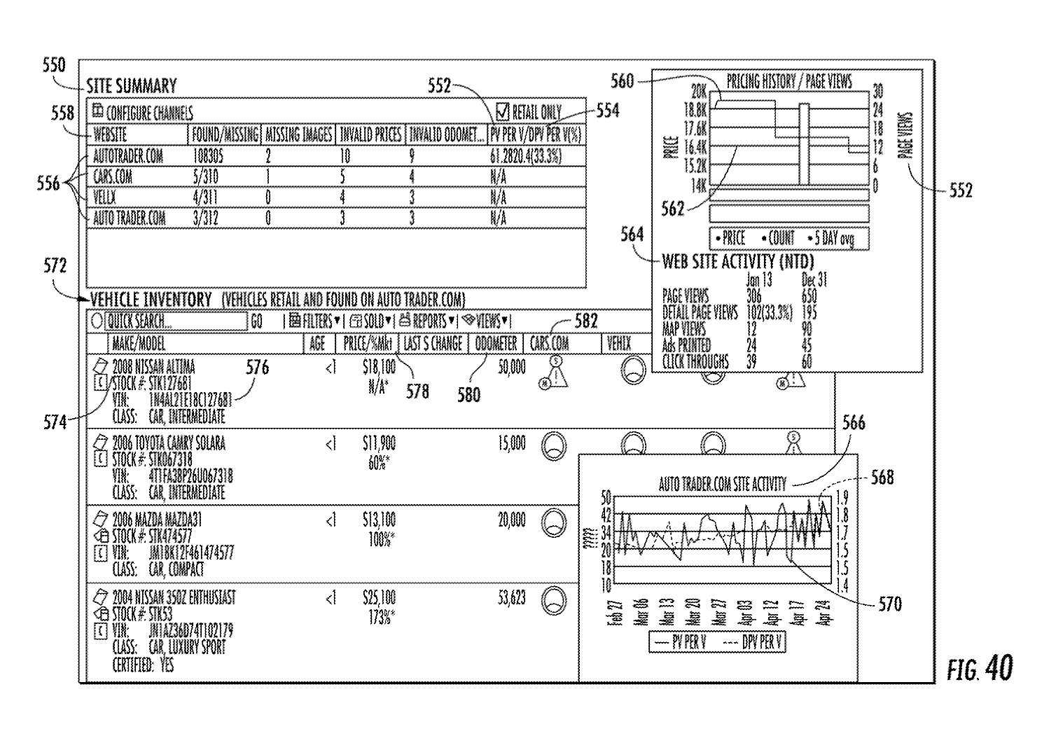

The Virtual View or Merchandising View of your vehicle inventory provides you a window into how well each vehicle is being represented on your advertised sites. As shown in FIG. 40, it is a quick snapshot as to the completeness and correctness of each vehicle's information on-line. With visible ease, the present invention allows one to regularly inspect the virtual inventory vehicle-by-vehicle, and then determine what actions need to be taken to present a sharper image.

The Site summary chart 550 is configured to reflect the 3^{rd} party sites on which the dealer advertises. It provides a summary of what the dealership inventory looks like on these sites. Page views 552 track anytime your ad has been displayed in an internet shoppers search. Detailed page views 554 count anytime a shopper drills down on an initial add to view specific pictures or description. This number helps determine how effective your dealership has been at merchandising your inventory—were your prices competitive enough, your pictures eye-catching enough, and descriptions compelling enough such that a shopper drilled down for more detail.

By moving the mouse over any of the icons 556 under the websites 558 and the list price history 560 can be tracked designated by the line, as it corresponds with the number of page views 552. This helps to identify the sweet spot—meaning that price-point where the reduced price affords the most page views but still allows for the optimal gross. Below the graph 562, is the breakout of the website's activity 564, month-to-date. This is like a vehicle's advertisement report card.

Click on the Page View or Detailed Page View numbers and a Site Activity graph appears to the right 566. This graph 566 shows by date, the number of hits for page views 568 and number of hits for detail page views 570. Checking the patterns provides insight into the website's activity.

The Live Market View page shown in FIG. 40 also provides a vehicle inventory section 572, for detailing the dealer's inventory being displayed on a particular automobile website, such as autotrader.com. The information listed can include the year, make and model of the automobile 574, the Vehicle Identification Number 576, price and percentage of market 578, odometer reading 580 and which websites it is being advertised on 582, among others.

### Compelling Description Generator: AutoWriter

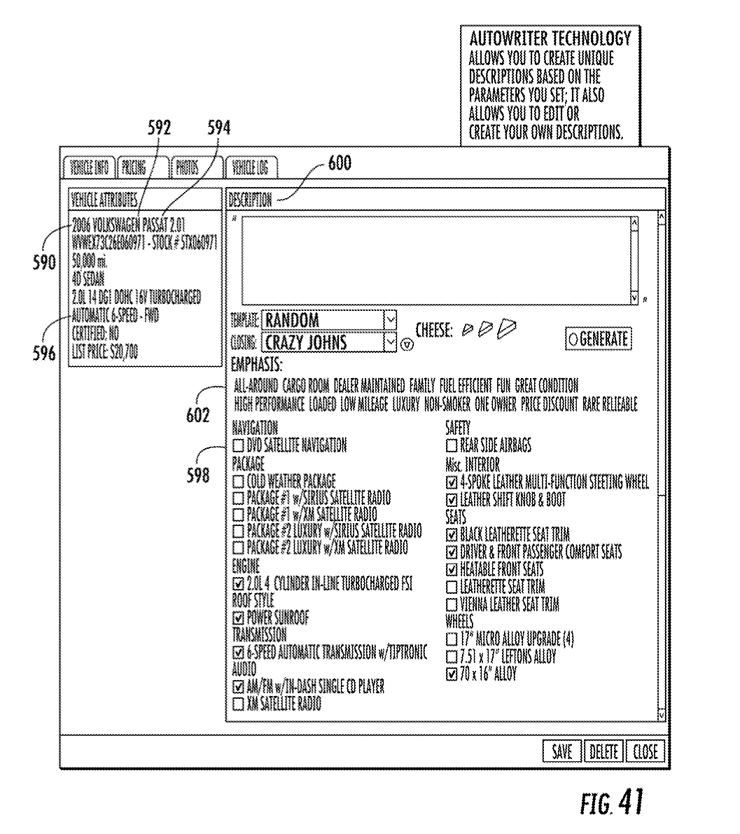

FIG. 41 shows the display for the present invention's compelling description generator, which dynamically generates a one-of-a kind description for each and every car in the market including the year 590, make 592, model 594, equipment 596 and features 598. The software allows dealers the ability to customize their descriptions with specific phrases, phone numbers and dates. The description generator or AutoWriter doesn't use repetitive templates but, rather, generates rich, persuasive descriptions 600. In addition to generating sentences, AutoWriter enables dealers to emphasize the unique attributes 602 of each of their automobiles, for example low mileage, high performance and fuel efficiency.

While the apparatus and method herein disclosed forms a preferred embodiment of this invention, this invention is not limited to that specific apparatus and method, and changes can be made therein without departing from the scope of this invention, which is defined in the appended claims.

1. A method for managing inventory and optimizing a selling price of a focus vehicle using a customer reporting tool to obtain an optimal sale, comprising the steps of:
designating a focus vehicle, said focus vehicle having a make, model, year and mileage;
obtaining information of at least one vehicle-for-sale using said customer reporting tool, said at least one vehicle-for-sale having a similar make, model and year as said focus vehicle;
comparing the at least one vehicle-for-sale and said focus vehicle;
optimizing the selling price of the focus vehicle based on the information of said at least one vehicle-for-sale;
displaying the information of said at least one vehicle-for-sale and the information of said focus vehicle to a customer;
Allowing said customer to remotely access said information of said at least one vehicle-for-sale and the information of said focus vehicle.

2. The method for managing inventory and optimizing the selling price of a focus vehicle to obtain an optimal sale of claim 1, wherein said information of the at least one vehicle-for-sale includes the selling price.

3. The method for managing inventory and optimizing the selling price of a focus vehicle to obtain an optimal sale of claim 1, wherein said information of the at least one vehicle-for-sale includes the mileage.

4. The method for managing inventory and optimizing the selling price of a focus vehicle to obtain an optimal sale of claim 1, wherein said information of the at least one vehicle-for-sale includes the value ranking.

5. The method for managing inventory and optimizing the selling price of a focus vehicle to obtain an optimal sale of claim 1, wherein said information of the at least one vehicle-for-sale includes the number of days to sell the at least one vehicle-for-sale.

6. The method for managing inventory and optimizing the selling price of a focus vehicle to obtain an optimal sale of claim 1, wherein comparing the at least one vehicle-for-sale and said focus vehicle, comprises the step of generating an ordered list of said at least one vehicle-for-sale and said focus vehicle, taking into account one or more of the selling price, mileage or value ranking.

7. The method for managing inventory and optimizing the selling price of a focus vehicle to obtain an optimal sale of claim 1, wherein optimizing the selling pricing of focus vehicle, comprises the step of determining the optimal selling price for the focus vehicle based on the selling price and mileage of the at least one vehicle-for-sale.

8. The method for managing inventory and optimizing the selling price of a focus vehicle to obtain an optimal sale of claim 6, wherein displaying the information of said at least one vehicle-for-sale and the information of said focus vehicle to a customer comprises the step of allowing the customer to view said ordered list of said at least one vehicle-for-sale and said focus vehicle.

9. The method for managing inventory and optimizing the selling price of a focus vehicle to obtain an optimal sale of claim 8, wherein allowing the customer to view said ordered list of said at least one vehicle-for-sale and said focus vehicle, comprises allowing the customer to view a computer screen.

10. The method for managing inventory and optimizing the selling price of a focus vehicle to obtain an optimal sale of claim 8, wherein allowing the customer to view said ordered list of said at least one vehicle-for-sale and said focus vehicle, comprises allowing the customer to view a printed report.

11. The method for managing inventory and optimizing the selling price of a focus vehicle to obtain an optimal sale of claim 8, wherein allowing the customer to view said ordered list of said at least one vehicle-for-sale and said focus vehicle, comprises allowing the customer to view a cellular telephone display.

12. The method for managing inventory and optimizing the selling price of a focus vehicle to obtain an optimal sale of claim 8, wherein allowing the customer to view said ordered list of said at least one vehicle-for-sale and said focus vehicle, comprises allowing the customer to view a website page.

13. The method for managing inventory and optimizing the selling price of a focus vehicle to obtain an optimal sale of claim 8, wherein allowing said customer to remotely access said information of said at least one vehicle-for-sale and the information of said focus vehicle comprises providing the customer with an access code such that said customer can use said access code to view said ordered list on at least one of a cellular telephone, computer display, or mobile device.

14. The method for managing inventory and optimizing the selling price of a focus vehicle to obtain an optimal sale of claim 13, wherein allowing said customer to remotely access said information of said at least one vehicle-for-sale and the information of said focus vehicle comprises providing the customer with an access code such that said customer can use said access code to view said ordered list after leaving a dealership.

15. The method for managing inventory and optimizing the selling price of a focus vehicle to obtain an optimal sale of claim 1, wherein said customer reporting tool comprises a website that aggregates information about vehicles-for-sale and allows for reports to be generated based on information about those vehicles-for-sale.

16. The method for managing inventory and optimizing the selling price of a focus vehicle to obtain an optimal sale of claim 1, wherein a dealership can track a customer that remotely accesses said information of said at least one vehicle-for-sale and the information of said focus vehicle.

17. The method for managing inventory and optimizing the selling price of a focus vehicle to obtain an optimal sale of claim 16, wherein a dealership tracking a customer that remotely accesses said information of said at least one vehicle-for-sale and the information of said focus vehicle comprises obtaining data when said customer remotely accesses said information of said at least one vehicle-for-sale and the information of said focus vehicle, communicating with a customer when said information of said focus vehicle is revised, communicating with a customer when said information of at least one vehicle-for-sale is revised.

18-31. (canceled)
